(19) United States
(12) Patent Application Publication
(10) Pub. No.: US 2003/0055985 A1
(43) Pub. Date: Mar. 20, 2003

(54) System and method for integrating voice over internet protocol network with personal computing devices

(76) Inventors: Joshua Corb, Simi Valley, CA (US); Brian Charbonneau, Simi Valley, CA (US); Mark Lovretovich, Westlake Village, CA (US); Sumeet Gupta, Simi Valley, CA (US); Sean Lemster, Simi Valley, CA (US); Daniel Hoai-Nguyen Doan, Thousand Oaks, CA (US); Charles Rice, Simi Valley, CA (US); Todd William Lehr, Thousand Oaks, CA (US); Tyler Lee Robinson, Simi Valley, CA (US); Jon deOng, Simi, CA (US)

Correspondence Address: Stanley J. Gradisar, Gibson, Dunn & Crutcher LLP, Suite 4100, 1801 California Street, Denver, CO, 80202, US

(21) Appl. No.: 10/212,330

(22) Filed: Aug. 5, 2002

Related U.S. Application Data
(60) Provisional application No. 60/309,918, filed on Aug. 6, 2001.

(51) Int. Cl. G06F 15/16; H04Q 11/00; H04L 12/16

(52) U.S. Cl. 709/227; 709/230; 709/205; 370/260

(57) ABSTRACT

A method and system state-of-the-art private VoIP network for delivery of high quality, lower cost voice and data services to business customers across the United States. The unique implementation of the latest networking and Internet technologies over a privately managed network produces Quality of Service that rivals traditional circuit-switched calls and allows customers to capitalize on the convergence of traditional circuit-switched voice networks with packet-based networks. Proprietary account management, call detail recording, and accounting software complements the equipment and satisfies the administrative needs of business customers. Customers receive the added security and flexibility of “virtual private networks” through the implementation of IP technology, advanced switching equipment, and Asynchronous Transfer Mode (“ATM”) operation of the fiber optic backbone.

### FIELD OF THE INVENTION

This invention relates generally to a packet-switched fiber optic private network for the purpose of transporting voice, data, and video telephony using the Internet Protocol, referred to as Voice over Internet Protocol (“VoIP”), and more particularly to a unique method and system for transporting voice, data, and video telephony that optimizes traffic across the private network that results in high speed, inexpensive, and reliable voice, data, and video traffic.

### BRIEF DESCRIPTION OF THE DRAWINGS

FIG. 1 shows a block diagram of the major components of an embodiment of the system for transporting voice, data, and video telephony of the present invention.

FIG. 2 shows a block diagram of an embodiment of the transport system for voice, data, and video telephony of the present invention.

FIG. 3 shows a block diagram of an embodiment of the administration and customer access of the system for transporting voice, data, and video telephony of the present invention.

FIG. 4 shows a block diagram of an embodiment of the types of service of the system for transporting voice, data, and video telephony of the present invention.

FIG. 5 shows a flowchart of the method of receiving digital data within a POP in an embodiment of the VoIP private network of the present invention and transmitting VoIP voice data across the WAN backbone to a remote POP.

FIG. 6 shows a flowchart of the method of receiving VoIP voice data over the WAN backbone in a remote POP in an embodiment of the VoIP private network of the present invention and transmitting the call to the final destination.

FIGS. 7 to 42 are screen shot representations of Web pages accessible to a customer through a Web Browser which demonstrate the customer interface of the present invention.

FIGS. 43 to 58 are screen shot representations of Web pages accessible to VoIP network personnel through a Web Browser which demonstrate the management interface of the present invention.

### DETAILED DESCRIPTION OF THE INVENTION

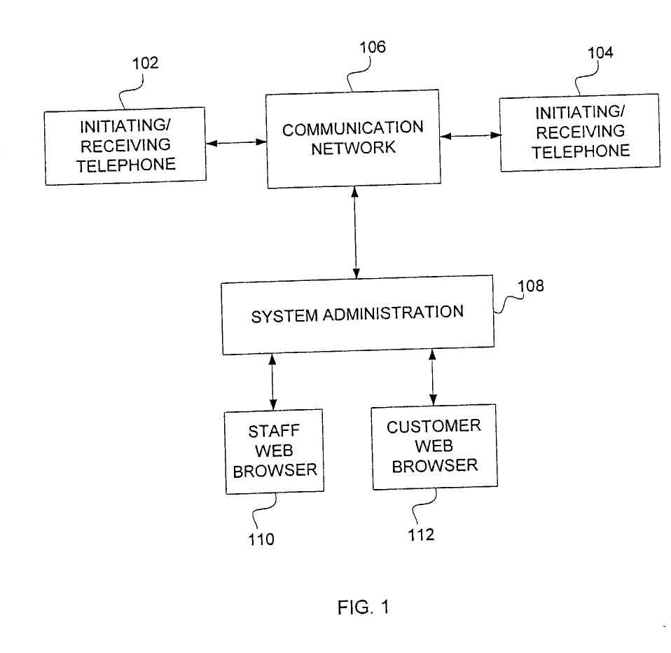

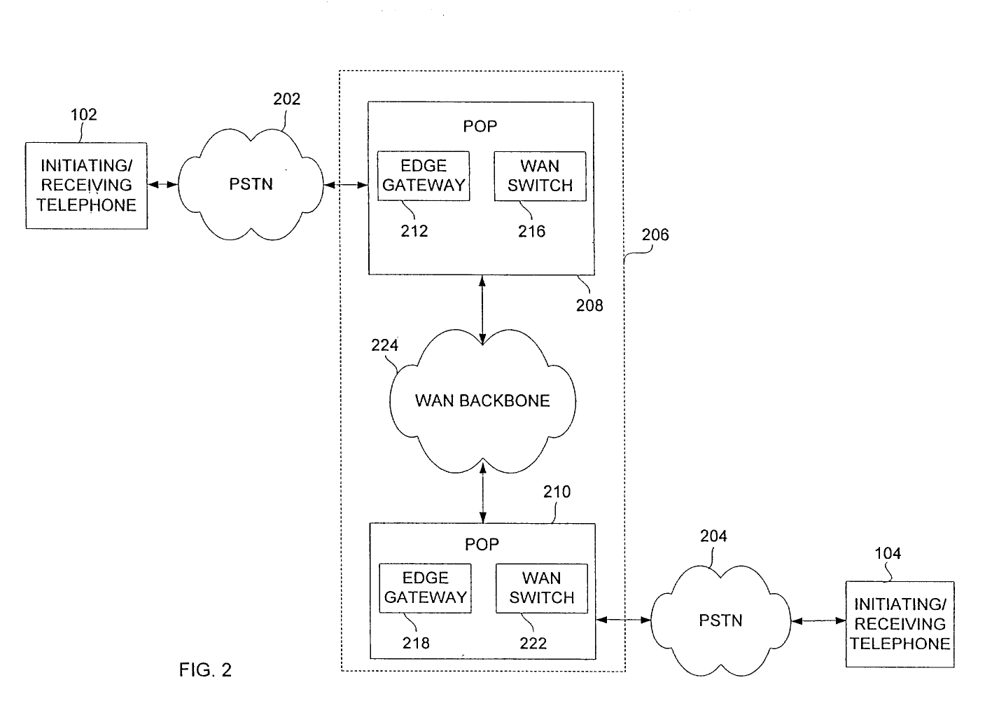

FIG. 1 shows a block diagram of the major components of an embodiment of the system for transporting voice, data, and video telephony of the present invention. Referring now to FIG. 1, initiating/receiving telephones 102/104 are connected to communications network 106, which includes the Public Switched Telephone Network (“PSTN”) and a private communications network (described more fully in FIG. 2). Tens of thousands or more initiating/receiving telephones 102/104 may be connected to communications network 106, but only two are shown for simplicity. Initiating/receiving telephones 102/104 may be residential or business phones and may be located in different geographic locations around the world.

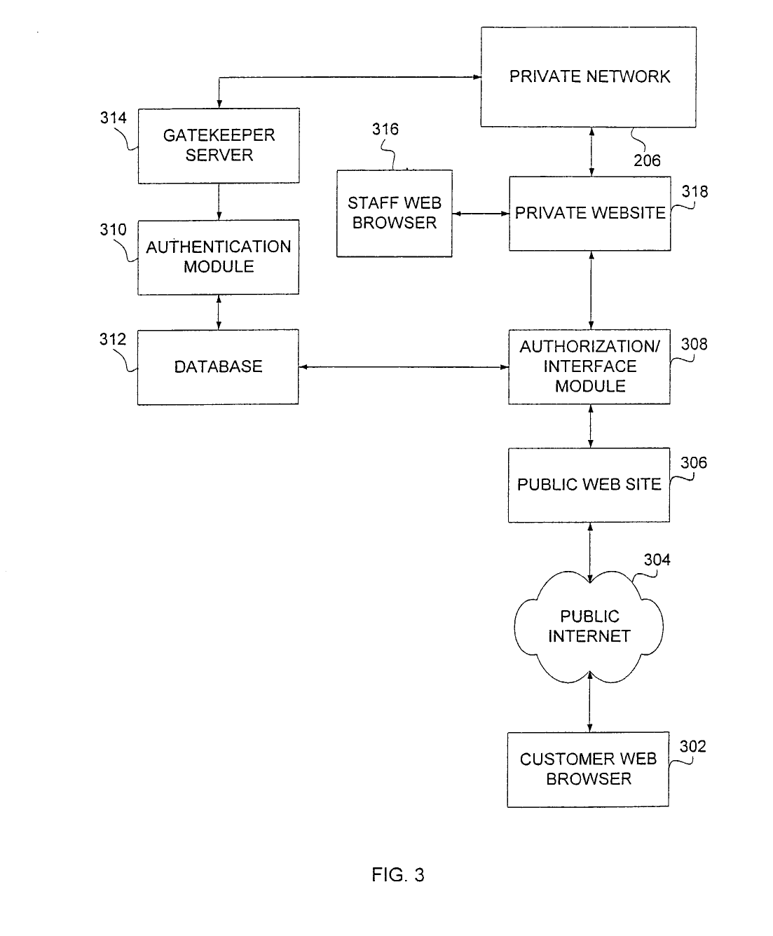

The private communications network intelligence is represented by system administration 108. A customer subscribing to the voice, data, and video telephony transport system of the present invention may access information regarding the customer's personal account via customer Web Browser 112 (described more fully in FIG. 3). Management and control of the voice, data, and video telephony transport system is secured through staff Web Browser 110 (also described more fully in FIG. 3).

The rapid development of the Internet has introduced a new dynamic market of Internet-based voice, data, video and facsimile communications, which has created a new communication paradigm based on the Internet Protocol (“IP”). The transmission of voice over the Internet has emerged as a potential low cost alternative to traditional long distance telephony. Initial attempts at telephony over the Internet were accomplished through use of personal computers and resulted in calls being sent across many “hops” of Internet switches. Unacceptable delays in the routing of these calls, and poor quality resulting from degradation and transfer delays at each hop along the network, rendered ordinary Internet telephony unsuitable for widespread commercial use. Communications services over the public Internet also suffered because providers typically did not have the ability to manage and control the network, thereby rendering it unable to guarantee voice traffic prioritization and provide Quality of Service (“QoS”) assurances. Bottlenecks and congestion are problems of chronic concern to users of the public Internet. These problems are avoided in the present invention. Though the Internet Protocol is used as a method of addressing and routing communications, the present invention does not use the public Internet for transport, but instead uses a private “backbone” network. Because the system of the present invention operates and controls its own private backbone network, it can manage traffic loads, anticipate growth, and provide the priorities and QoS guarantees that are not available on the public Internet. The method and system of the present invention controls the access and bandwidth allocation of the private network and therefore is able to guarantee the audio QoS, as well as system availability, that its target customers expect.

The method and system of the present invention implements a state-of-the-art private VoIP network for delivery of high quality, lower cost voice and data services to business customers across the United States. The unique implementation of the latest networking and Internet technologies over a privately managed network produces QoS that rivals traditional circuit-switched calls and allows customers to capitalize on the convergence of traditional circuit-switched voice networks with packet-based networks. The method and system of the present invention includes proprietary account management, call detail recording, and accounting software that complements the equipment and satisfies the administrative needs of business customers. Customers receive the added security and flexibility of “virtual private networks” through the implementation of IP technology, advanced switching equipment, and Asynchronous Transfer Mode (“ATM”) operation of the fiber optic backbone.

Packet-switched data networks using a core ATM “backbone” offer superior functionality to legacy circuit-switched networks and. When actively managed by a private provider, such networks utilizing IP and packet-switched technology may become the network of choice for voice, video, facsimile, and other voice-enabled services, as well as data traffic, which can be carried over the same network.

Historically, voice telephone calls have proceeded over dedicated circuits using the PSTN. Several new technologies have emerged which suggest that this traditional method of providing long-distance voice telephony using circuit switching is now obsolete and imposes an inordinate and unnecessary expense on business as well as residential customers. Fiber optic broadband networks, established by many firms, now span the country and allow for high-speed transmission of very high volumes of voice and data using the IP addressing mechanism, which allows interconnection among many different types of equipment. Another key development has been the implementation of “packet switching” across these broadband networks. Essentially, information to be transmitted (voice, data, video or facsimile) if not already in digital form is first digitized, then “vocoded” (compressed and encoded), and then sent in “packets” or “frames” over the network to a destination switch, where it is uncompressed (and converted to analog form, if necessary) and then delivered in the appropriate form to the end user. The advantages given by a packet-switched network allow for a more efficient usage of available bandwidth. Specifically, this efficiency is described as “statistical multiplexing.” Essentially this means that available bandwidth on a line can be filled with more packets, regardless of their contents. This differs from the circuit-switched model where a call is allocated a bandwidth of 64 kbps, regardless of usage. So any bandwidth unused by a call (silence, etc.) goes to waste. The bandwidth itself is the same, this is simply a more efficient usage. Packet switching networks can transport a far higher volume of data over a given medium.

The development of packet-switching technologies and networks has been at the core of the astonishing growth in use of the public Internet for data transmission using standard IP. Despite the theoretical efficiencies of using high-speed IP networks to carry voice traffic, QoS for VoIP has been problematic. Hence, today VoIP constitutes only a tiny percentage of the traffic currently transported over private IP networks. The method and system for transporting voice, data, and video telephony of the present invention eliminates the historical obstacles that have previously prevented the large-scale commercial exploitation of VoIP.

New network equipment technology that is utilized within the private network of the present invention has helped solve the QoS problem that has inhibited commercial exploitation of VoIP. The newest equipment has performance features which provide “toll-call quality” phone-to-phone VoIP when using a private, packet-switched network.

The new network switches and routers minimize the network “latencies” and delays otherwise experienced by previous generation routing and switching equipment and employ advanced techniques for the transfer and prioritization of delay-sensitive information, such as voice and video. In the private network implementation of the present invention, voice packets are assigned a special priority along with identification and routing information and are transmitted across the backbone of the private network in a single “hop” without any intermediate routing delays. Coast-to-coast transport of voice calls over the private network take no more time (and sometimes less) than what occurs over legacy circuit-switched systems. The method and system for transporting voice, data, and video telephony of the present invention delivers customer calls that are essentially indistinguishable, in sound quality, from what they would hear using any representative circuit-switched telephone carrier.

The present invention utilizes a nationwide private, packet-switched fiber optic network providing high-quality, low-cost, secured transport of voice, data, video, and facsimile. The private network design utilizes leading edge network equipment installed at strategic locations throughout the United States. The private network is operated using ATM for the primary purpose of carrying VoIP. IP is the addressing and end-to-end transport scheme which rides atop the ATM network. ATM provides the QoS assurances needed on the backbone.

The private network and its intelligence control systems eliminate the historical obstacles that have previously prevented the large-scale commercial exploitation of VoIP. While the private network is capable of carrying “data” traffic as well as “voice”, the present invention's solution identifies voice “packets” as they enter the private network and such voice traffic always receives priority over data (which is less time-sensitive). As a result, the present invention can provide superior VoIP services without the risk of congestion and overload that would degrade the necessary QoS.

The private network can carry live video, facsimile, and other image or data file traffic just as capably as voice, and without requiring any additional or distinctive network facilities. Obviously video would require very different network facilities on each end (camera, encoder, display, etc.), but the backbone itself can handle different applications without physical modification. Video and real time facsimile (as defined in ITU-T.38 Real Time Fax over IP) are similar to voice calls in that they are sensitive to delays in transmission that would compromise QoS, video being more so than real time facsimile. The same attributes that enable the present invention to carry voice with the high QoS will also allow the present invention to carry customers' video and facsimile traffic. The fiber optic network backbone structure is inherently fault-tolerant and backup route paths are available in the event of any point failure or obstruction. The installed equipment is robust and employs advanced “intelligent” addressing techniques that accomplish efficient call re-routing with minimal delays.

Using the equipment and private network strategies described above, the present invention is able to offer to each of its business customers a Virtual Private Network (“VPN”) using the high-capacity fiber optic backbone network. The architecture and operation of the private network allows high speed, high-quality transport of voice, facsimile and video from office-to-office, with a high degree of reliability, and without requiring the specific point-to-point dedicated lines or dedicated transmission equipment that formerly would be required to tie remote offices together for facility-to-facility voice communications. VPNs have many attractive features for sophisticated customers, notably predetermined, highly efficient routing, and a high degree of security.

The method and system of the present invention is able to deliver reliable, high-quality voice, video and facsimile via its private network using IP at a cost substantially below that of conventional InterExchange Carriers (“IXCs”). The total capital expense of the private VoIP network is substantially less than “legacy” infrastructure costs of conventional providers of circuit-switched telephony.

The fiber optic backbone connects each city in which a gateway is maintained. Point-to-point fiber, connecting the gateways, is leased from a variety of providers. Within the backbone, packetized information is transported using high capacity switch equipment. The capacity of these switches can be easily increased via equipment upgrades, such as circuit cards to increase ingress/egress ports, or use of higher bandwidths.

Each customer gains the advantage of a VPN using the hardware and leased fiber. This private network is used primarily for voice traffic and associated information services (facsimile or video), and only secondarily, on a managed non-interference basis, for other forms of data transfer. The private network is not shared with any other carrier.

Targeted customers are businesses with multiple offices, which seek to reduce the costs of inter-office long distance calls. The method and system of the present invention offers high-quality, high-functionality VoIP, ease of operation, and strong management and accounting services to such customers.

The flexible architecture allows for adaptation of the basic functionality of the VPN and the VoIP technology to different customer needs and different classes of potential customers. A high-volume customer may connect to the private network through a dedicated “T1” line, and would produce the lowest effective price to the customer. The same functionality can be achieved by delivering calls to and from a gateway via Digital Subscriber Line (“DSL”) services, ISDN, frame relay, or by using the PSTN.

FIG. 2 shows a block diagram of an embodiment of the transport system for voice, data, and video telephony of the present invention. Referring now to FIG. 2, analog voice data may originate from either initiating/receiving telephone 102 or 104. For purposes of this description, it is assumed that the analog voice data originates from initiating/receiving telephone 102 and that initiating/receiving telephone 102 has been provisioned for the transport system for voice, data, and video telephony of the present invention through subscribing for the service.

The analog voice data captured by initiating/receiving telephone 102 is converted into digital voice data within PSTN 202. PSTN 202 then forwards the digital voice data to the nearest Point Of Presence (“POP”) 208 associated with the present invention. The transport system for voice, data, and video telephony of the present invention may have multiple POP locations throughout the country, but only two are shown in FIG. 2 for simplicity. Within POP 208 is edge gateway 212 which handles the duty of ‘translation’ between the circuit-switched PSTN 202 and the packet/cell switched private network 206. Edge gateway 212 may be a MAX TNT or a MAX TNT2 manufactured by Lucent Technologies, or a similar and comparable piece of equipment. In one embodiment edge gateway 212 utilizes the International Telecommunications Union (ITU-T) G.729a standard for the compression and encoding/decoding of speech.

The frames of digital voice data are handed to the IP section of edge gateway 212 for encapsulation into an IP datagram for transmission upstream to WAN switch 216. WAN switch 216 may be a CBX-500 ATM switch or a CBX-500 ATM switch plus a GX-550 ATM switch, both manufactured by Lucent Technologies, or a similar and comparable piece of equipment. The CBX-500 ATM is currently the only switch directly doing IP duties. Once the IP traffic is encapsulated in ATM, the traffic can be carried on any ATM network. The GX-550 is simply a higher capacity ATM switch used when increased capacity is called for (OC-48 and greater) and currently has no direct IP duties. Conceptually, edge gateway 212, and the CBX-500 ATM and the GX-550 ATM within WAN switch 216 are the edge, border, and core of the private network, respectively.

In one embodiment the IP datagram is ITU-T H.323 compliant. Additional industry standards which may be utilized include: ITU-T H.245 for call control (for connecting and terminating calls); ITU-T H.323 for media control (for policing the media stream, i.e. voice traffic); Real-time Transport Protocol (RTP, as defined by IETF RFC1889) for the media stream itself, which is what the G.729a frames are put into. All of these are protocols within IP and specifically they range from layers 4-7 of the Open Systems Interconnection (OSI) Interconnect Model.

Within the IP layer, another protocol, the Resource Reservation Protocol (RSVP), aids in the allocation of network resources between POP 208 and POP 210. RSVP is functionally outlined in IETF RFC2750. For transit onto WAN backbone 224, which in one embodiment is an Asynchronous Transport Mode (ATM) backbone, the IP datagrams are encapsulated into ATM cells. These cells contain destination information corresponding to the POP 210 that services the destination of the call. At the ATM layer, specifically the encapsulation process, two key features are implemented. The first is a method for a tighter integration of the profoundly differing IP and ATM layers, known as Multi-Protocol Label Switching (“MPLS”). The second is the further integration of the ATM layer's QoS capabilities with the benefits of MPLS, which is implemented specifically on edge gateway 212 as IP Navigator from Lucent. The overall solid integration of IP connectivity along with QoS enforced via the ATM layer allows for much improved flexibility in supporting differing traffic profiles (voice and data) across WAN backbone 224. Configuration aspects of the WAN backbone 224 itself are handled via Naviscore, and its extensions to IP Navigator. Naviscore itself is a set of extensions to the HP Openview management environment.

There are in reality two autonomous systems at work ensuring QoS relating to voice traffic: RSVP and IP Navigator. Because the IP layer is functionally oblivious to the ATM layer, which subsumes IP and everything above it, the packets conceptually only take a ‘single hop’ between POP 208 and POP 210. The traffic itself is traveling one IP hop, which may actually be multiple ATM hops. Although instead of hops, which implies a decision being made at each point on where to send the traffic, a predetermined path through the private network is determined through Virtual Circuit Switching; A label denoting which Virtual Circuit an ATM cell belongs to is contained in the header of the ATM cell.

The link between edge gateway 212 and WAN switch 216 is typically 100baseT Ethernet (100 megabits per second). The link from the WAN switch 216 into WAN backbone 224 (which will connect to another edge gateway 218 in POP 210) is at least a DS-3 which when running ATM yields approximately 40 megabits per second (mbps), and more commonly is an OC-3 (approximately 155 mbps) and tops out at OC-12 (approximately 622 mbps). The GX-550 is capable of OC-48 connections (approximately 2.4 gigabits per second). The MAX TNT2 (also know as the APX-8000) supposedly has better ATM capabilities than the MAX TNT, so OC-3 may become a viable interconnect into WAN switch 216/222. The interconnection to the PSTN of edge gateway 212 is channelized DS-3, provided either by the local telephone company (“telco”) or multiplexed from DS-1s provided by the telco.

To clarify the interface between POP 208 and PSTN 202, POP 208 receives the IP voice packets, handles all decoding of the packets, opens a connection to PSTN 204 via its dedicated links, and transmits voice in a digital format familiar to PSTN 204. PSTN 204 does not participate in any manipulation of voice data, and is there solely to complete the ‘last mile’ of the call.

Due to the fact that the telephony services of the present invention are IP based, great freedom is given in the design of a large WAN such as WAN backbone 224, as there are a wide range of transport methods friendly to IP. IP is a communications format oblivious to the underlying transport mechanism, so in theory as long as the underlying mechanism can move an IP datagram from one point to another, you have IP connectivity. Beyond simple connectivity, requirements of the application at hand must be taken into account. Voice telephony demands a basic assurance of quality, and perhaps more importantly, that quality needs to be consistent.— So in order for the undertaking to be successful, quality-assured IP service must be provided. The term ‘quality IP service’ has long been an oxymoron of sorts in the industry. IP is inherently a service delivered in terms of ‘Best Effort’, so if the IP datagram makes it to the other end, it is purely by chance, albeit a very good chance. In other words, IP has no abilities to dictate quality which are core to the concept of IP itself.

There are extensions to IP which attempt to alleviate the pure Darwinism of the IP model, such as RSVP. RSVP is implemented on each POP and participates in negotiations between POPs for a quantity of ‘resources’ reserved on the POP itself. This concept of resources amounts to network availability and processor time on the POP, and speaks nothing of the transport medium used between POPs, which is vastly more crucial to the delivery of a quality IF telephony call. So, in summation, the quality of an IP telephony call is directly related to the quality of the link between POPs.

After this analysis, the requirements of the private network are: links capable of carrying IF traffic, quality transport of said traffic, and ability to support massive bandwidths (since scaling of the system may continue indefinitely). When applying these requirements to network technologies available, ATM has immediate appeal, and upon further analysis, is the clear winner. ATM links can carry IF traffic. ATM ensures quality through fine-grained control of bandwidth usage on a link. ATM supports bandwidth in the range of several gigabits per second. In order to -pick up in features where IP falls short, ATM represents a complete paradigm shift from IF in its architecture. ATM communicates with the concept of a Virtual Circuit, or a logical direct connection between two points with a predefined level of quality, whereas IF is a connectionless protocol which essentially forwards a packet verbatim to the next link en route to its destination. In IF the destination is known, but the path is subject to routing decisions made by each IP router along the way. These routing decisions take time. ATM virtual circuits imply a predetermined destination and path through the private network. Looking at the nature of voice traffic itself, it is highly time-dependent. Changes in IP voice traffic flows manifest themselves as warped or distorted audio. These variations in the flow of speech at best annoy the people on the call, and at worst make the call altogether unusable. So consistent traffic flow is key to maintain the flow of different sounds which make up speech. The primary antagonists to the smooth flow of traffic are latency, or the time required for a packet to traverse the network and arrive at its destination, and jitter, or delay variation, which is the change in latency between arriving packets. Jitter is the bigger obstacle of the two, as it is much harder to compensate for than latency, which says nothing about the traffic flow itself. ATM is, by design, suited to handle time-sensitive traffic, due to its granularity of bandwidth allocation, and the construction of predefined paths through the network. The scheme of predefined paths, known as switching, removes the relatively time-consuming forwarding decision process inherent to a routed IP network, and thus has the effect of greatly smoothing the flow of traffic. The gateways themselves attempt to compensate for jitter through buffering some of the voice traffic to allow for smooth playback to the end user. These jitter buffers can help, but with widely varying amounts of latency and jitter, voice traffic can still easily break down. But in combination with the improved traffic flow characteristics of ATM, jitter is essentially eliminated. The method and system of the present invention utilizes IP at the edge and ATM at the core of the transport system.

The next issue is the unification of the two into a seamless system. The first tendency is to carry ATM as far as possible, to take advantage of its benefits in order to minimize the introduction of additional latency and jitter into the network. The MAX TNT has limited ATM capabilities. These were fully explored and rejected due to the sub-par performance of ATM hardware on the MAX TNT.

Another option utilizes a router (not shown in FIG. 2) in-between edge gateway 212 and WAN switch 216 essentially doing the translation of IP to ATM. The GRF series of routers manufactured by Lucent Technologies are preferred because they are high capacity IP and ATM capable routers. In one embodiment, edge gateway 212 is connected to the GRF router via 100baseT Ethernet, and the GRF router up-links to WAN switch 216 via OC-3 (155 mbit) running ATM. This fully-functional design was implemented in the private network to a limited extent and proven to be a stable VoIP platform. So technically the gap was bridged between the IP and ATM worlds. GRF routers in each market talk to each other via ATM virtual circuits which are predefined by the network administrator and handle the passing of VoIP traffic between gateways. This means that whenever a new market is brought into service, the network administrator must build a virtual circuit between the new GRF and all existing GRFs on the private network. This ‘mesh’ of virtual circuits must be correctly maintained, despite growing exponentially with the addition of each new market. Thus this platform, while very functional and theoretically scalable, would create massive management headaches down the road, thus putting a glass ceiling on scalability and as such is not a preferred embodiment. The preferred embodiment as shown in FIG. 2 utilizes MPLS to support the building of the virtual circuit mesh. MPLS is implemented in Lucent's IP Navigator and resides locally on WAN switch 216. In addition to this software, additional hardware for WAN switch 216, namely the 100baseT Ethernet interface, condenses the IP abilities of the GRF routers into a slot card on WAN switch 216. The MPLS abilities of IP Navigator are what allowed for the removal of the separate GRF router. It allows the WAN switch 216 to handle the duties that originally required a separate GRF router. The CBX-500 ATM is currently the only switch directly doing IP duties. The GX-550 is simply a higher capacity ATM switch used when increased capacity is called for (OC-48 and greater) and currently has no direct bearing on IP Navigator functions.

Edge gateway 212 is now directly up-linked into the ATM backbone, removing an additional source of latency/jitter and greatly simplifying management tasks on the private network, naturally improving scalability, not to mention removing another point of failure. So in FIG. 2 MPLS is responsible for the unification of IP routing and ATM switching, and greatly lessens the management burden, while retaining the beneficial characteristics of both communication methods.

As further integration of the IP abilities of MPLS with ATM's traffic management features continues, one skilled in the art will recognize that new capabilities may be introduced into the private network. An example would be controlled peering of other VoIP capable networks, as is currently handled on the PSTN by a tandem switch. This could now be done in the sense of a ‘virtual IP tandem’ where multiple providers could exchange traffic at the IP level, taking advantage of VoIP's cost savings, versus doing costly circuit-switched peering.

The configuration of the POPs is constantly evolving, and with each evolution, there are usually an improved set of interconnects that go along. For instance, gatekeeper servers, such as gatekeeper server 314 of FIG. 3, may be geographically distributed, meaning that the larger traffic POPs in each region may have their own gatekeeper server (not shown in FIG. 2) doing gatekeeper duties mounted in the rack alongside edge gateway 212 and WAN switch 216. One skilled in the art will recognize that other pieces of equipment may be added to improve redundancy and fail over and may be implemented as conditions permit.

The IP datagrams encapsulated into ATM cells sent over WAN backbone 224 in a single hop arrive at the destination POP 210, avoiding intermediate routing delays, and are received in edge gateway 218. Edge gateway 218 decompresses the IP voice packets received and WAN switch 222 then sends them to destination PSTN 204. PSTN 204 serves to complete the delivery of the call to initiating/receiving telephone 104.

FIG. 3 shows a block diagram of an embodiment of the administration and customer access of the system for transporting voice, data, and video telephony of the present invention. Referring now to FIG. 3, a customer subscriber to the method and system for transporting voice, data, and video telephony can access information about his or her account using the public Internet 304 and customer Web Browser 302. Through public Web Site 306 the customer is given access to certain information regarding private network 206. An authorization/interface module 308 located between public Web Site 306 and private network 206 authenticates the customer's identification and password and determines which data the customer is to be given access to regarding private network 206. Assuming a valid ID and password, authorization/interface module 308 references a security profile belonging to that user ID. The security profile simply lists what abilities the customer has within authorization/interface module 308. Authorization/interface module 308 is for management of the services provided. Information passed to and from authorization/interface module 308 resides in database 312 common to authorization/interface module 308 and private network 206. Database 312 is essential to the scalability of a customer base and gives the ability to maintain a central record of all available services and all provisioning and management aspects of those services.

A customer can do several things from customer Web Browser 302 which accesses certain features enabled by proprietary software. A customer can monitor certain data in real time. A typical customer is a business with many telephone lines. Such a customer can monitor in real time the number of its lines that are dialed into private network 206, and the length of each telephone call to or from-a customer line. In addition, the customer can use customer Web Browser 302 to assign a speed dial code to certain numbers. Customer Web Browser 302 also allows the customer to perform many management functions without assistance with respect to its account from public Web Site 306. For example, online bill presentment and payment is available, along with usage analysis to determine the best value calling plan. Optional features include an on line phone book and unified messaging.

Giving the customer the ability to watch their account usage in real time for whatever purpose has not been done to this scale before. The closest analogy is sitting at the console of a PBX feeding calls to a dedicated call center. But in the implementation of the method and system of the present invention the usage of any one account can be tracked with a global scope. So instead of a manager watching the PBX to track his marketing force, the analogy is extended to a manager watching his virtual call center, tracking his employees who can now be located virtually anywhere.

A staff Web Browser 316 interfaces with private Website 318 allowing VoIP private network personnel to control private network 206 and to access information about it. Private network data that is available using staff Web Browser 316 includes network performance and usage data, error logs, technical and engineering information regarding the network, etc. Both proactive and reactive monitoring of services are enabled via staff Web Browser 316. Alerts for exceptional conditions may be sent via the Web, or email, pager, etc. Automated provisioning is enabled via an interface with VoIP private network vendors as sell as real time management of private network costs from information supplied by the vendors. Staff Web Browser 316 also allows real time access to customer data, such as billing information, the current status of the customer's account, etc. Using staff Web Browser 316, VoIP private network personnel can communicate with customers via the public Internet 304. Staff Web Browser 316 has permissions above that of customer Web Browser 302 to modify information in the common database 312 upon which authentication module 310 operates. Communication between staff Web Browser 316 and private network 206 is handled via database 312.

Authentication module 310 interfaces with the POPs (FIG. 2) in private network 206 via gatekeeper server 314 and authorization/interface module 308. Authentication module 310 performs several functions and carries out those functions based on data retrieved from database 312. One such function is the authentication of a user's ID and password. Authentication module 310 also prevents fraudulent use of private network 206 by looking for specific indicia of fraud. For example, authentication module 310 may be programmed to look for calls by a particular user to unauthorized telephone numbers. Similarly, it may be programmed to look for calls by a particular user that exceed a specified number during a given time period.

Authentication module 310 also gathers certain types of private network data, such as overall use of the private network or specific resources. It also can be programmed to identify private network equipment that is being heavily used or has gone down, and route calls around that equipment.

Gatekeeper software resides on Gatekeeper server 314 and serves to maintain communication between the edge gateways and authentication module 310. The gatekeeper software is essentially authentication module 310's means of communication with the edge gateways. Authentication module 310 is responsible for the actual routing and accounting logic. Gatekeeper server 314 may be located anywhere within private network 206. The gatekeeper software maintains a list of telephone numbers and corresponding IP addresses. Each WAN switch (FIG. 2) uses a table to determine the IP address of a destination WAN switch. Such table look up is known in the art and is often referred to as a spanning tree or virtual circuit switching. The gatekeeper software in one embodiment is Lucent MultiVoice Access Manager (“MVAM”), and has an Application Programming Interface (“API”) which gives direct control of how calls are handled between edge gateways in each POP (FIG. 2). The core technologies at work in MVAM are IP, H.323, and their supporting components. The MVAM architecture consists of an edge gateway (FIG. 2) and the gatekeeper software and its API through which authentication module 310 interfaces, linking to proprietary back office functions. The MVAM specification speaks only of what is relevant to completing and accounting for a VoIP call, and says nothing of interim transport methods used. So, in essence, MVAM describes a workable system for talking between edge gateways and gatekeeper software, as if they were adjacent to each other. An aspect of the present invention is to extend the capabilities of the MVAM platform across thousands of miles, into a working global long-distance telephony network. The obstacles introduced in architecting a WAN backbone capable of supporting the MVAM platform in a scalable and reliable manner across vast distances, not to mention international boundaries and differing technological paradigms implied therein, are quite different from hooking them back-to-back and making a call complete.

The gatekeeper software has its own functions to facilitate routing and accounting of calls, although they are simplistic and not suited to provide the scalability required by a telephony network. In the implementation of the present invention these functions are handled by authentication module 310. This proprietary module, also called Keymaster, interfaces with the edge gateways via the gatekeeper software, as well as database 312 common to authorization/interface module 308. Authentication module 310 carries out its functions based on information retrieved from database 312 regarding both authorization information for the account, and routing information required to complete the call to the remote edge gateway. Authentication module 310 is a custom application which provides ultimate fine-grained control of the telephony call, while providing scalability due to its level of integration with database 312. Regarding database integration, in one embodiment the authentication module 310 methods of communicating with database 312 are standards-based Open Database Connectivity (“ODBC”) and will talk to any database which complies with those standards. All Structure Query Language (“SQL”) servers comply with these standards, and there is nothing specific to any one database vendor.

Authentication module 310 is responsible for: call authorization, call routing, and call accounting. Some functions in one category hinge on the result of functions in another category. For example, available routes for calls are dictated by the results of the authorization of the calling user. Specifically, call authorization allows or disallows access to private network 206 based on a number of methods: currently Personal Identification Number (“PIN”) and Automatic Number Identification (“ANI”). This functionality may be extended to any combination of unique identifiers present when making a call. Call routing is handled by a pre-populated database of areas covered by private network 206 in conjunction with attributes tied to the account of the calling party which can dictate available calling areas.

For every destination, there are multiple routes available to complete the call. These routes are selected in whatever manner is desired, usually the one with the least cost first. This also provides for alternate routes to complete the call should the first selection be unavailable for whatever reason. Call accounting functions simply record the stop and start times of the call as the related stop and start notices are received from the edge gateways involved in completing the call. This figure has rates applied to it in database 312, then the proper account's information is updated.

The proprietary software of authentication module 310 is integrated with the equipment to provide customers with accounting, network, and utilization management tools. The proprietary accounting system provides detailed billing and usage monitoring for VoIP services. The billing system provides customers with immediate, real time access to billing information and calling patterns. The billing system generates a call detail record and corresponding bill immediately upon the termination of each call. The billing system also generates and continuously updates call reports, billing records, and utilization information, which is instantly available at the command of the customer via remote access from customer Web Browser 302, 24 hours a day, seven days a week.

Private network data is stored in database 312. Off the shelf database software products, such as Microsoft's OLAP and Sequel, may be used to collect and store data in specific formats and to perform data searches.

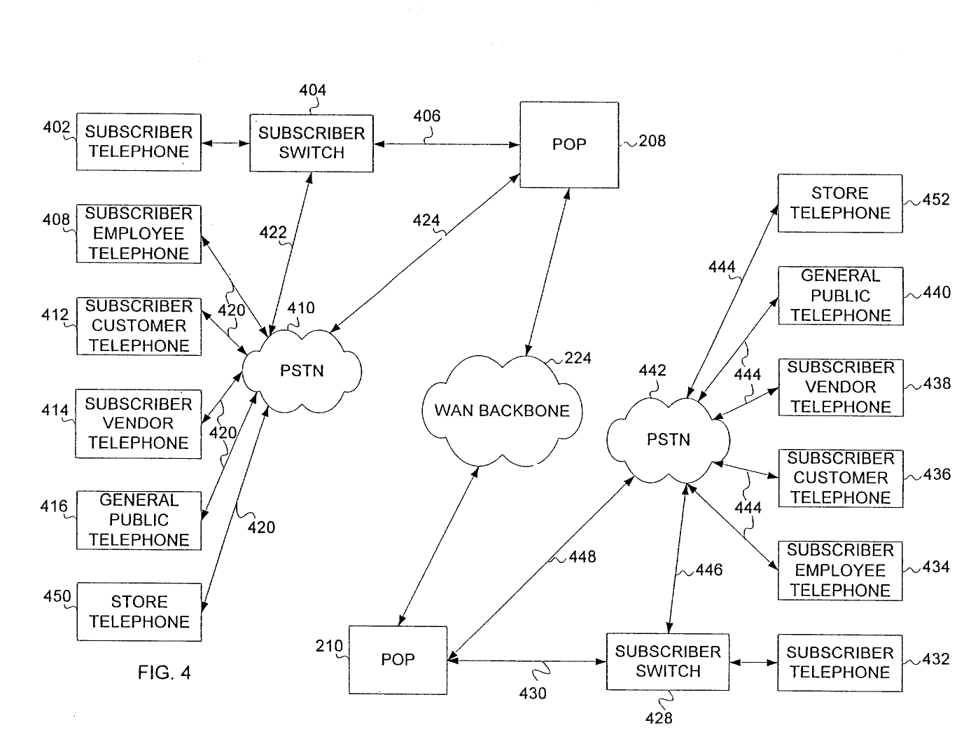

FIG. 4 shows a block diagram of an embodiment of the types of service of the system for transporting voice, data, and video telephony of the present invention. Referring now to FIG. 4, four different types of service, referred to as Tier One, Tier Two, Tier Three, and Tier Four are shown. A major focus is on serving large companies that have a substantial volume of office-to-office local long and long-distance voice and data traffic, and companies with a high volume of voice traffic between pre-established destinations who are seeking a lower cost alternative to traditional long-distance service. Significant savings can be realized by such business customers for their inter-office calls (and facsimile traffic) being handled by the VoIP private network.

The VoIP private network can be upgraded rapidly and may be provisioned for growth in arrangements for “co-location” space at its POP locations and in supporting agreements with competitive local exchange carriers (“CLECs”) and Incumbent Local Exchange Carrier (“ILECs”) who for some subscribers will originate calls to or terminate calls from the VoIP private network.

The VoIP private network co-exists with the conventional PSTN, thereby enabling corporate subscribers to route their office-to-office or other traffic via conventional long-distance providers at any time, should the need arise. A subscriber may connect directly to the VoIP private network POP using a dedicated T1 line. For some services, the VoIP private network has interconnect relationships with CLECS and ILECS for low cost “first mile” and “last mile” call handling. Favorable primary rate interface (“PRI”) agreements allow the VoIP private network to expand the geographical areas served by its POPs and therefore reduce its capital expenditures by allowing service to more customers with fewer POP installations.

Tier One Service: Office-to-Office via a T1 line. This business-to-business customer will use the VoIP private network primarily for office-to-office voice, facsimile, and video communications. For this class of customer, the Tier One Service is most efficient. Each participating customer facility (e.g., an office in New York, an office in Chicago, and an office in Los Angeles) would be connected to the nearest VoIP private network POP by a T1 or other dedicated, private line. At each customer location, the subscriber's switch would identify all office-to-office calls for routing to the VoIP private network via the dedicated line. At the POP, the call would be digitized and packetized, assigned VoIP priority tags, and then transported in a single “hop” across the ATM backbone to the VoIP private network POP nearest the destination customer facility. The call would then be carried by T1 to the customer's destination site. Substantial cost savings are possible with this architecture, as it avoids entirely the expensive long-distance and local exchange infrastructure of traditional carrier routes, without requiring the high expense of long-distance dedicated switched lines. This “private carriage” bypasses the PSTN entirely.

Tier One Service is accompanied by management, accounting and billing features that are important to managers as well as users of the customers it serves. For the employees of customers using Tier One Service, the VoIP private network offers attractive ease of use as well as QoS equal to conventional circuit-switched calls. An employee of a Tier One customer will be able to place voice calls or transmit facsimiles to any other connected office location using a simple dialing scheme no more difficult to execute than an intra-office call from one extension'to another. No elaborate or special dialing schemes are required. Nor is any special training needed. Indeed, a Tier One business-to-business system is designed specifically to complement and co-exist with the customer's other local, local long, and long-distance arrangements. This not only offers substantial cost savings to the customer, but improves customer “security” as vulnerability to interruption in PSTN facilities is reduced.

For example, a Tier One Service office-to-office call may be executed as follows. A subscriber telephone 402 is connected to subscriber switch 404 (required for Tier One Service). A T1 line 406 carries the call to POP 208 over WAN backbone 224 to POP 210. T1 line 430 carries the call to subscriber switch 428 which is connected to subscriber telephone 432. Tens of thousands or more subscriber telephones 402/432 may be connected and provisioned with Tier One service, but only two are shown for simplicity.

Tier Two Service: Office-to-Office Plus. VoIP services over the VoIP private network may be further enhanced to increase utility and value to core business subscribers while maintaining the favorable regulatory position that contributes to the cost/price advantage of the present invention. Many business subscribers using Tier One Service will be able to identify a defined group of “outside” numbers repeatedly called by its employees, e.g., important customers and vendors. The VoIP private network can take such calls originating from the subscriber's facility and route these over the VoIP private network to the POP nearest the location of the call destination. From the POP, the call will be carried over the PSTN to its ultimate point of termination. Favorable arrangements with CLECS and ILECS allow for low-cost provision of these so-called “last mile” services.

The Tier Two Service takes advantage of the capability of typical on-premises customer telephone switch equipment which stores records of frequently-called numbers. When a business subscriber selects such a number from among those either stored on his or her individual phone set, or stored as a workgroup or “system” telephone number, the switch automatically routes the call through the dedicated T1 line to the nearest POP and onto the private network. Thus, all of the cost savings of using the private network and packet voice communication are achieved. A termination charge will be payable to the CLECS and ILECS at the call destination, and that local carrier will be responsible to pay applicable access and FCC charges. Under current law the provision of telephony services to a “closed user group” on a customer-specific basis is considered a “private carrier” and not a “common carrier” service. Hence, under current law certain of the VoIP private network service offerings will not be subject to the federal or state rules applicable to common carriers. By providing services beyond voice telephony, such as data, video and facsimile carriage, the VoIP private network also may offer “enhanced information services” which also are presently outside regulation as telecommunications services.

For example, a Tier Two Service office-to-vendor or office-to-customer call may be executed as follows. Frequently called vendors and customers of the subscriber, represented in simplicity by subscriber customer telephone 412/436 and subscriber vendor telephone 414/438, stored in subscriber switch 404/428 respectively, are included in Tier Two service. A call initiated from subscriber telephone 402 to subscriber vendor telephone 438 will travel from subscriber telephone 402 to subscriber switch 404 over T1 line 406 to POP 208 through WAN backbone 224 to POP 210 over line 448 to PSTN 442 over line 444 to subscriber vendor telephone 438. A call initiated from subscriber telephone 432 to subscriber customer telephone 412 will travel from subscriber telephone 432 to subscriber switch 428 over T1 line 430 to POP 210 through WAN backbone 224 to POP 208 over line 424 to PSTN 410 over line 420 to subscriber customer telephone 412.

The business subscribers can also select another Tier Two Service that again leverages the same dedicated, high-capability network and its low-cost structure. The business-to-business subscribers can choose to provide a VoIP private network access number to their employees. When working off-premises, employees will be able to call the employer's nearest facility (that is connected to a POP) and then have the remainder of their call routed over the VoIP private network to other customer offices or to other destinations.

For example, a Tier Two Service working off-premises employee call may be executed as follows. An access number may be given to a subscriber's employee to access the VoIP private network when away from the subscriber's office, represented in simplicity by subscriber employee telephone 408/434. For example, a call initiated off-premises from subscriber employee telephone 408 will travel over line 420 to PSTN 410 over line 422 to subscriber switch 404 over T1 line 406 to POP 208 through WAN backbone 224 to POP 210. From POP 210 the call will travel either over T1 line 430 or to PSTN 442 depending upon the final destination of the call.

Tier Three Service: Office-to-General Public. Corporate customers using Tier One and Tier Two Services may also use the VoIP private network to carry their voice calls and facsimile transmissions to the general public. Such telephone numbers can be routed as VoIP calls over the VoIP private network. This allows corporate customers to have an alternate means to traditional IXCs for long-distance carriage. It also allows business customers the option of concentrating their service requirements and fully exploiting the flexible, real time call reporting, traffic management, and billing systems. The “last mile” of such telephone calls would be handled by arrangements with the CLECs and ILECs that provide local access for calls, while using the VoIP private network for the long-haul component. At the present time, it is not believed such calls would be subject to “access charges” or other FCC regulatory costs.

For example, a Tier Three Service office-to-general public call may be executed as follows. Subscribers may also make calls to the general public represented in simplicity by general public telephone 416/440. For example, a call initiated from subscriber telephone 402 to general public telephone 440 will travel from subscriber telephone 402 to subscriber switch 404 over T1 406 to POP 208 through WAN backbone 224 to POP 210 over line 448 to PSTN 442 over line 444 to general public telephone 440.

Tier Four Service: Small Businesses. The VoIP private network may also offer service to provide savings to small businesses with multiple locations. Representative Tier Four customers are retail or wholesale businesses with many locations. Tier Four Service handles store-to-store voice and facsimile transmissions. Access to and from the VoIP private network would be through negotiated local Primary Rate Interface agreements with CLECs and ILECs. In-store phones would be programmed to route store-to-store calls through the VoIP private network. Even allowing for the possibility that ingress and egress charges would be paid to access the VoIP private network, and other FCC-mandated charges, there are considerable cost savings for such small business customers in contrast to other long-distance solutions. Should a national or regional headquarters be connected to the VoIP private network via a T1 line (thus receiving the “Tier One” Service), such a customer could achieve even greater savings and functionality. The headquarters facility could realize “value added” by employing the capability of the VoIP private network for distribution of multi-office facsimiles.

For example, a Tier Four Service store-to-store call may be executed as follows. Subscribers may make calls from one store to another store represented in simplicity by store telephones 450/452. For example, a call initiated from store telephone 450 to store telephone 452 will travel from store telephone 450 over line 420 to PSTN 410 over line 424 to POP 208 through WAN backbone 224 to POP 210 over line 448 to PSTN 442 over line 444 to store telephone 452.

To-and-From the General Public. The VoIP private network may also support telephone calls to and from the general public in much the same way as described above for store to store calls. Both intra-state and inter-state calls may be handled over the VoIP private network.

International IP Calls. International IP telephony through private transport of IP formatted voice to international destinations is also supported.

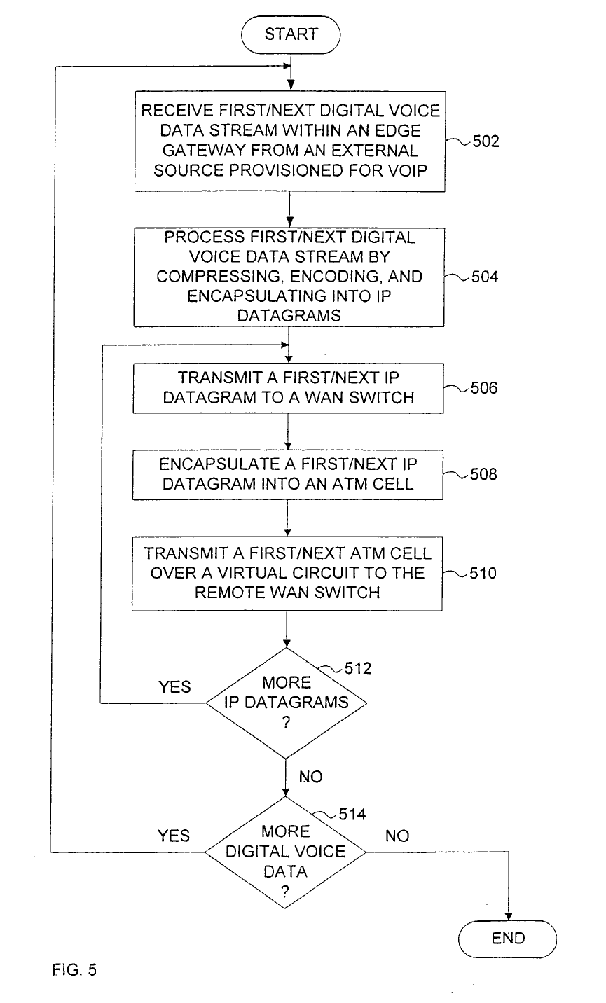

FIG. 5 shows a flowchart of the method of receiving digital data within a POP in an embodiment of the VoIP private network of the present invention and transmitting VoIP voice data across the WAN backbone to a remote POP. Referring now to FIG. 5, a telephone provisioned with VoIP service, such as subscriber telephone 402 or store telephone 450, initiates a call. In step 502, edge gateway 212 within POP 208 receives a digital voice data stream either from line 424 from PSTN 410 or from T1 line 406 from subscriber switch 404. Step-504 compresses, encodes, and encapsulates the digital voice data stream into IP datagrams. Edge gateway 212 transmits the IP datagrams to upstream WAN switch 216 in step 506.

WAN switch 216 in step 508 encapsulates the IP datagrams into ATM cells. In step 510 the ATM cells are transmitted over WAN backbone 224 to the next WAN switch, such as WAN switch 222 in POP 210. MPLS features come into play in this step by associating a Virtual Circuit on WAN backbone 224 connecting WAN switch 216 with a destination IP address. Virtual Circuits are pre-established between all the WAN switches within private network 206. This occurs when IP interfaces are configured on each WAN switch. Since the path is predetermined, there is only transmission taking place, which is why switching is faster than routing.

Step 512 determines if there are more IP datagrams to be processed. If yes, control returns to step 506 where the next IP datagram is transmitted to WAN switch 216. If the determination in step 512 is no, then step 514 determines if a next digital voice data stream from another call is being received. If yes, control returns to step 502. If step 514 determines that no more digital voice data streams are being received, then the method of the present invention ends.

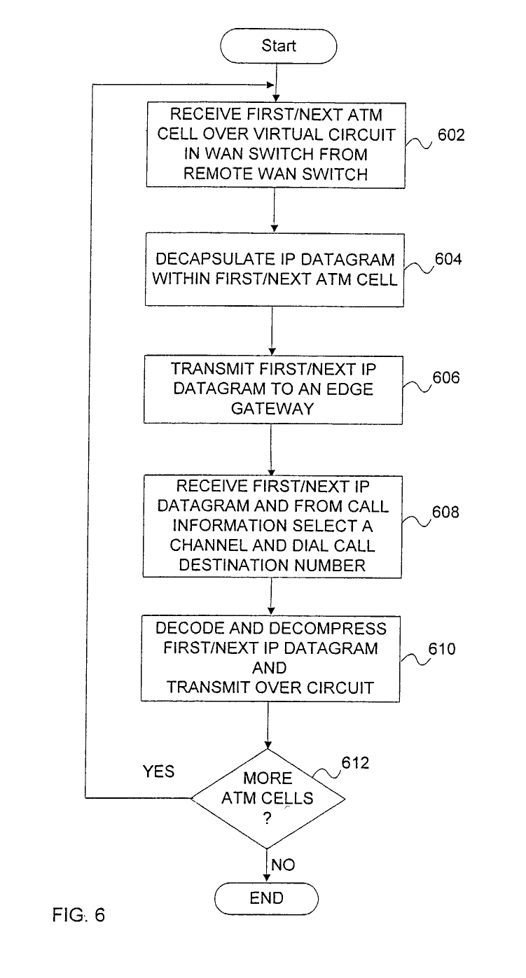

FIG. 6 shows a flowchart of the method of receiving VoIP voice data over the WAN backbone in a remote POP in an embodiment of the VoIP private network of the present invention and transmitting the call to the final destination. Referring now to FIG. 6, in step 602 an ATM cell is received in WAN switch 222 over the Virtual Circuit from WAN switch 216. The IP datagrams within the ATM cells are de-capsulated (the ATM cell headers are stripped) in step 604. In step 606 the IP datagram is transmitted to edge gateway 218. Edge gateway 218 in step 608 receives the IP datagram, and based on ITU-T H.245, call setup information, selects a channel from the pool of the dedicated PSTN circuit-switched connections, picks up the channel, and dials the destination number of the call. Upon connection of the PSTN circuit, in step 610 edge gateway 218 begins the decoding and decompression of the ITU-T G.729a audio frames and transmission of audio data onto the established PSTN circuit. Step 612 determines if there are more ATM cells to receive. If yes, control returns to step 602. If not, then the method of the present invention ends.

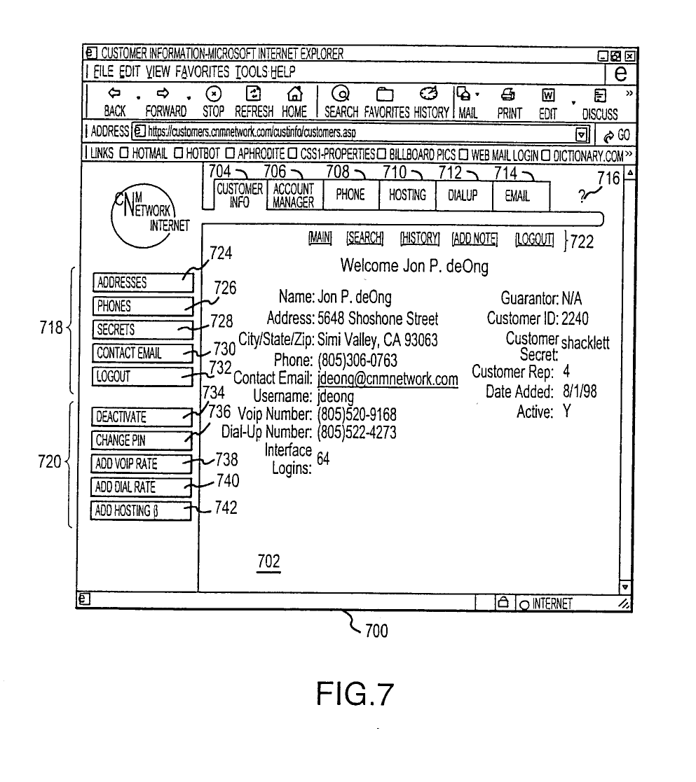

FIGS. 7 to 42 are screen shot representations of Web pages accessible to a customer through a Web Browser which demonstrate the customer interface of the present invention. Referring now to FIGS. 7 to 42, after a customer or user of the VoIP private network of the present invention requests the URL of the VoIP private network public website 306 via customer Web Browser 302, the home page is displayed (not shown). Customer Web Browser 302 may be Microsoft Internet Explorer or Netscape Navigator or any other appropriate Web Browser. Microsoft Internet Explorer is the Web Browser shown in FIGS. 7 to 42.

From the home page, the customer is invited to login to access the customer's account information by entering a user name and password in a window presented on the home page. Authorization/interface module 308 authenticates the user name and password entered and, if the user name and password are valid, retrieves Customer Info Web Page 700 from-public Web Site 306 and returns it to customer Web Browser 302 for display. Frame 702 displays the customer's general account information. Customer info tabs 704, 706, 708, 710, 712, and 714 give the customer access to various account functionality. Help icon 716 allows the customer to access an on-line help function. In FIG. 7 Customer Info tab 704 is active, giving the customer access to several select buttons 718. The customer may click on any of the select buttons 718 to access the feature represented by the particular select button.

A staff member of the VoIP private network may access any of the Web pages that a customer can from staff Web Browser 316. When a staff member accesses Customer Info Web Page 700, additional select buttons 720 are presented, as well as several links 722. The staff member may click on any of select buttons 718, select buttons 720, or links 722 to access the features represented by them.

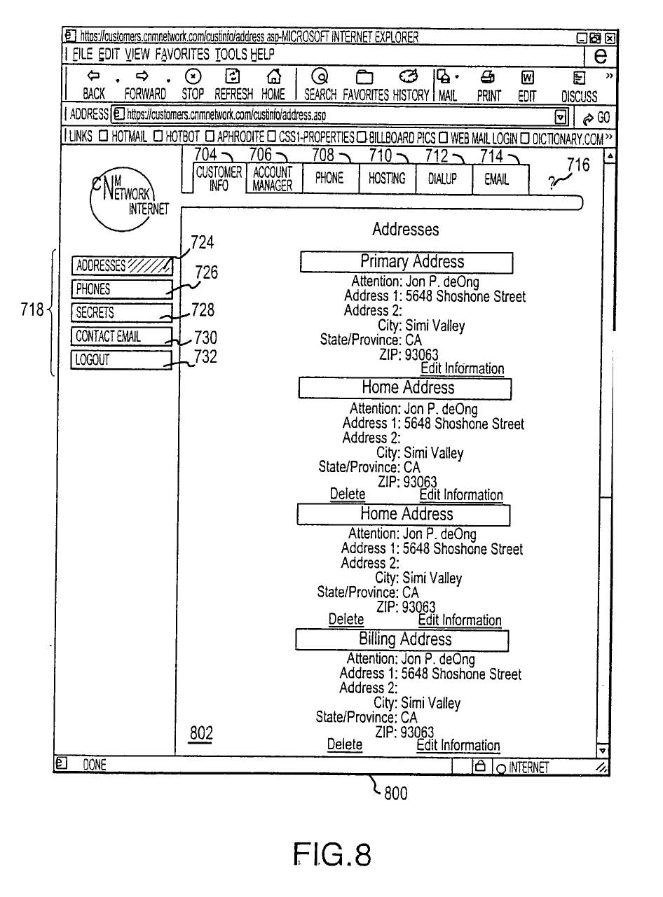

Clicking on Addresses select button 724 causes Addresses Web Page 800 of FIG. 8 to be displayed on customer Web Browser 302. Frame 802 displays address information about the customer and allows the customer to modify address information as appropriate.

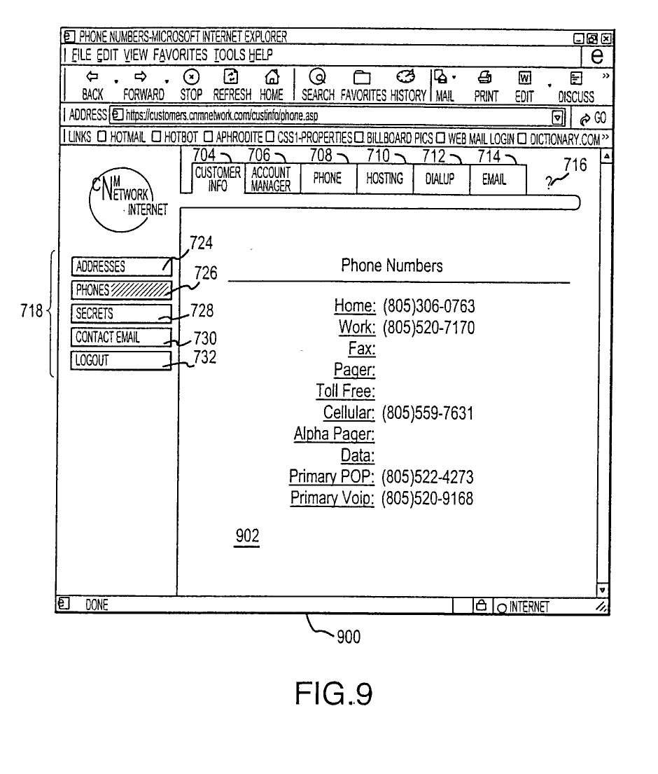

Clicking on Phones select button 726 causes Phone Numbers Web Page 900 of FIG. 9 to be displayed on customer Web Browser 302. Frame 902 displays phone information about the customer and allows the customer to modify phone information as appropriate.

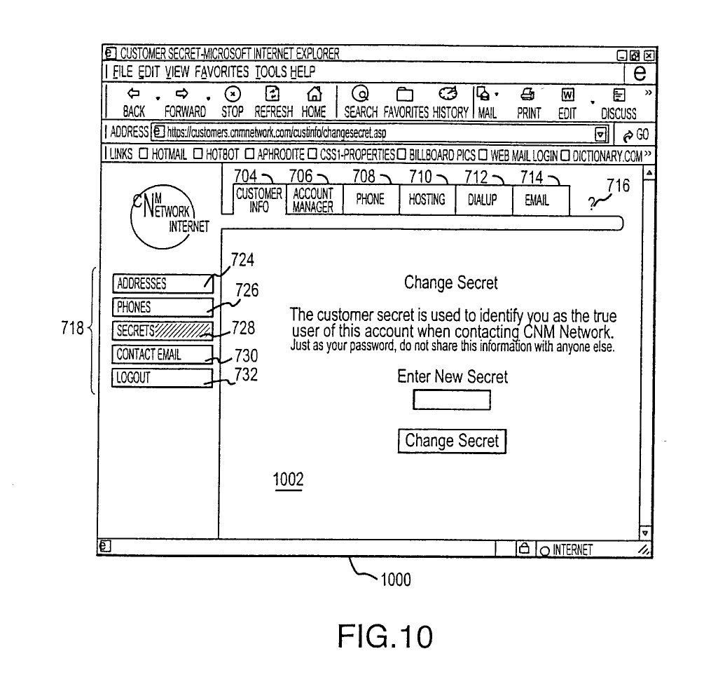

Clicking on Secrets select button 728 causes Change Secret Web Page 1000 of FIG. 10 to be displayed on customer Web Browser 302. Frame 1002 displays secret “code” word information about the customer and allows the customer to modify the secret “code” word information as appropriate.

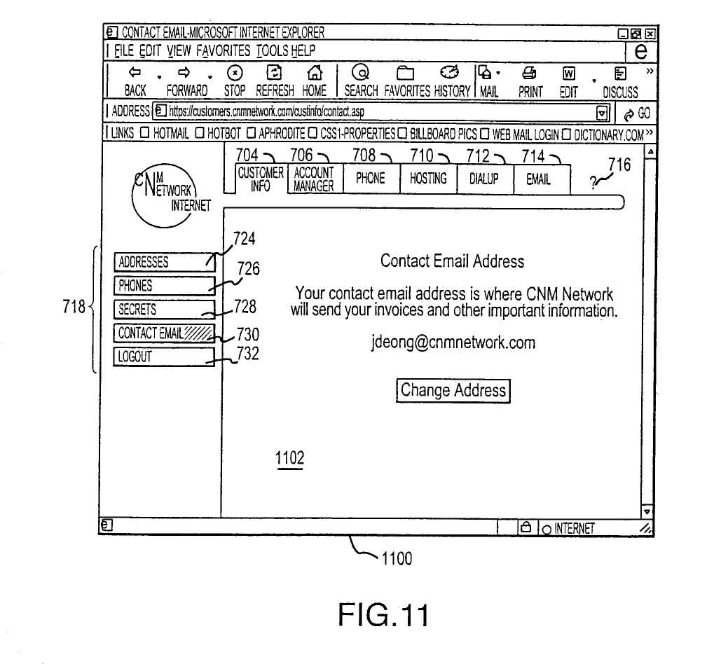

Clicking on Contact Email select button 730 causes Contact Email Address Web Page 1100 of FIG. 11 to be displayed on customer Web Browser 302. Frame 1102 displays email contact information about the customer and allows the customer to modify email contact information as appropriate.

Clicking on Logout select button 732 will log the customer out of the account information portion of the Web Site and return the customer to the home page.

Referring now to the additional select buttons 720 of FIG. 7 which are only displayed when a staff member accesses Customer Info Web Page 700, clicking on Deactivate select button 734 causes the customer account to be deactivated so that it can no longer be used. This is a staff member function only.

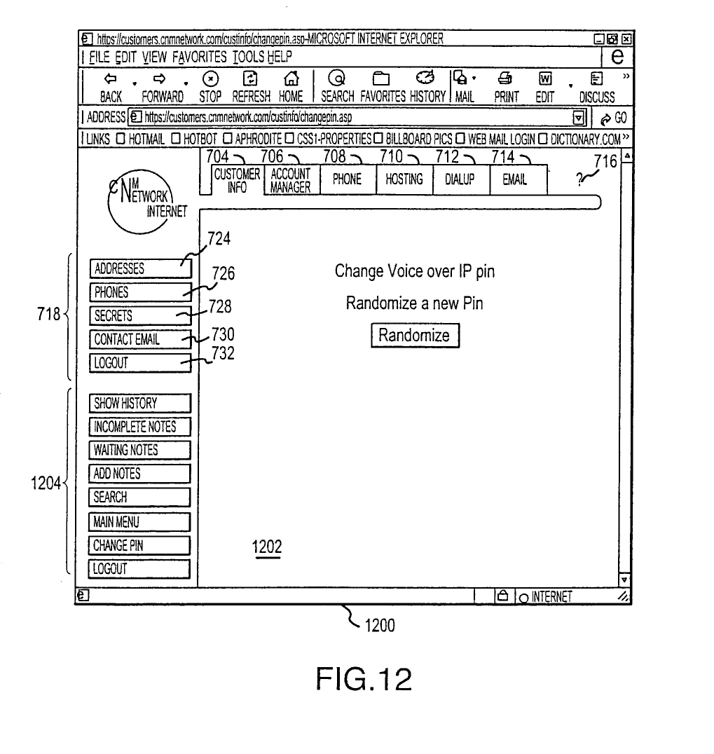

Clicking on Change PIN select button 736 causes Change Voice over IP PIN Web Page 1200 of FIG. 12 to be displayed on customer Web Browser 302. Frame 1202 displays information allowing the PIN number for the customer to be changed. This is a staff function only. Change Voice over IP PIN Web Page 1200 also gives the staff member access to several select buttons 1204. The staff member may click on any of the select buttons 1204 to access the features represented by the select button.

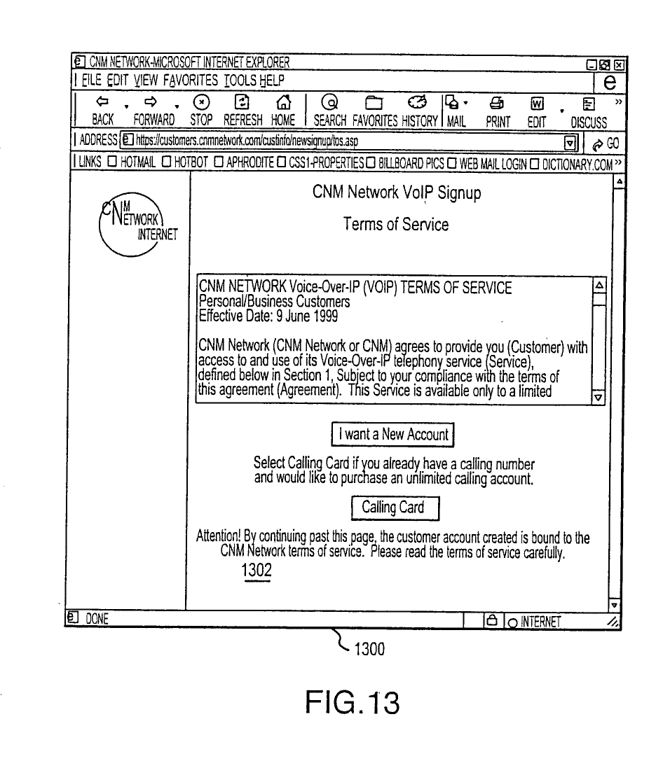

Clicking on Add VoIP Rate select button 738 causes VoIP Signup Web Page 1300 of FIG. 13 to be displayed on customer Web Browser 302. This allows a VoIP rate to be added to the account of a customer who already has a rate of another type. This is a staff member function only.

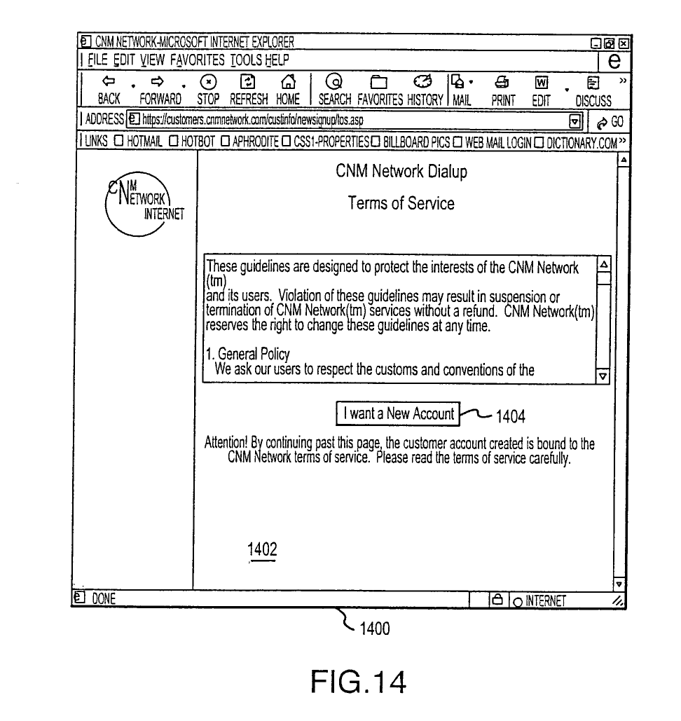

Clicking on Add Dial Rate select button 740 causes Add Dialup Web Page 1400 of FIG. 14 to be displayed on customer Web Browser 302. Frame 1402 displays information that allows a dialup rate to be added to the account of a customer who already has a rate of another type. This is a staff member function only.

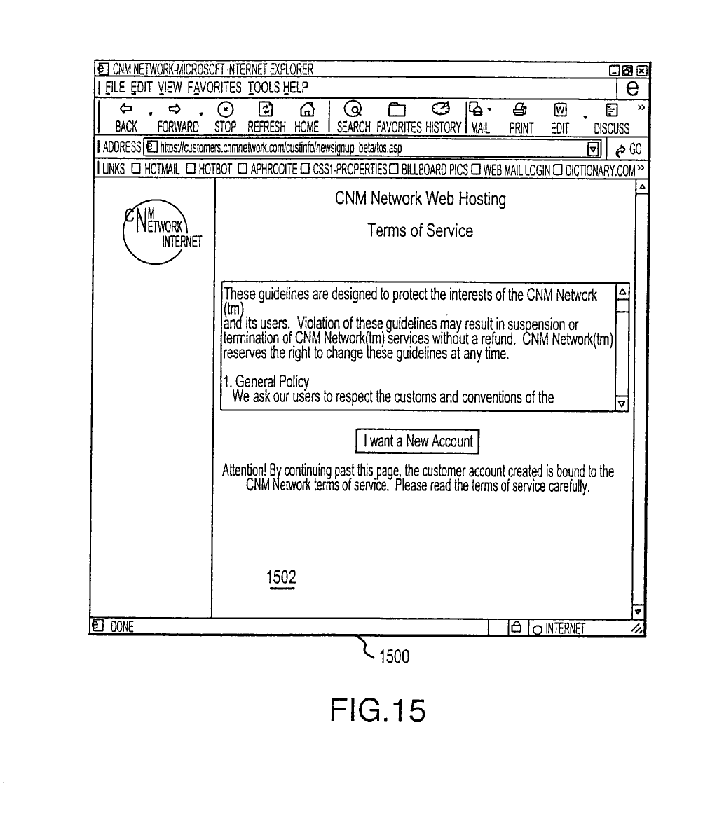

Clicking on Add Hosting select button 742 causes Web Hosting Web Page 1500 of FIG. 15 to be displayed on customer Web Browser 302. Frame 1502 displays information that allows a hosting rate to be added to the account of a customer who already has a rate of another type. This is a staff member function only.

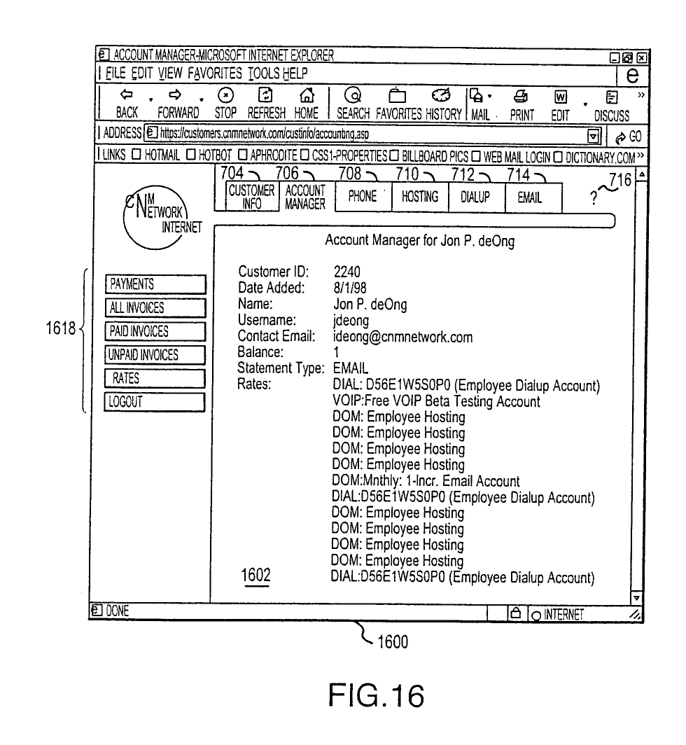

Selecting Account Manager tab 706 causes Account Manager Web Page 1600 of FIG. 16 to be displayed on customer Web browser 302. Frame 1602 displays the customer's specific account information and rates for the types of service the customer has signed up for. Account Manager tab 706 gives the customer access to several select buttons 1618. The customer may click on any of the select buttons 1618 to access the features represented by the select button and see more information about the customer's account.

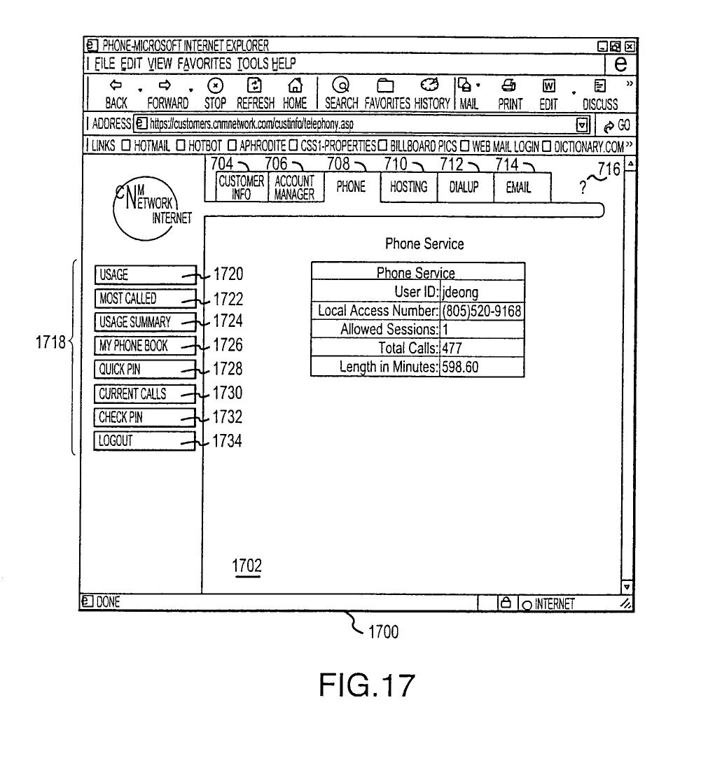

Selecting Phone tab 708 causes Phone Service Web Page 1700 of FIG. 17 to be displayed on customer Web browser 302. Frame 1702 displays information about the customer's phone service, such as user ID, local access number, total calls, length in minutes, etc. Phone tab 708 gives the customer access-to several select buttons 1718. The customer may click on any of the select buttons 1718 to access more information about the phone service.

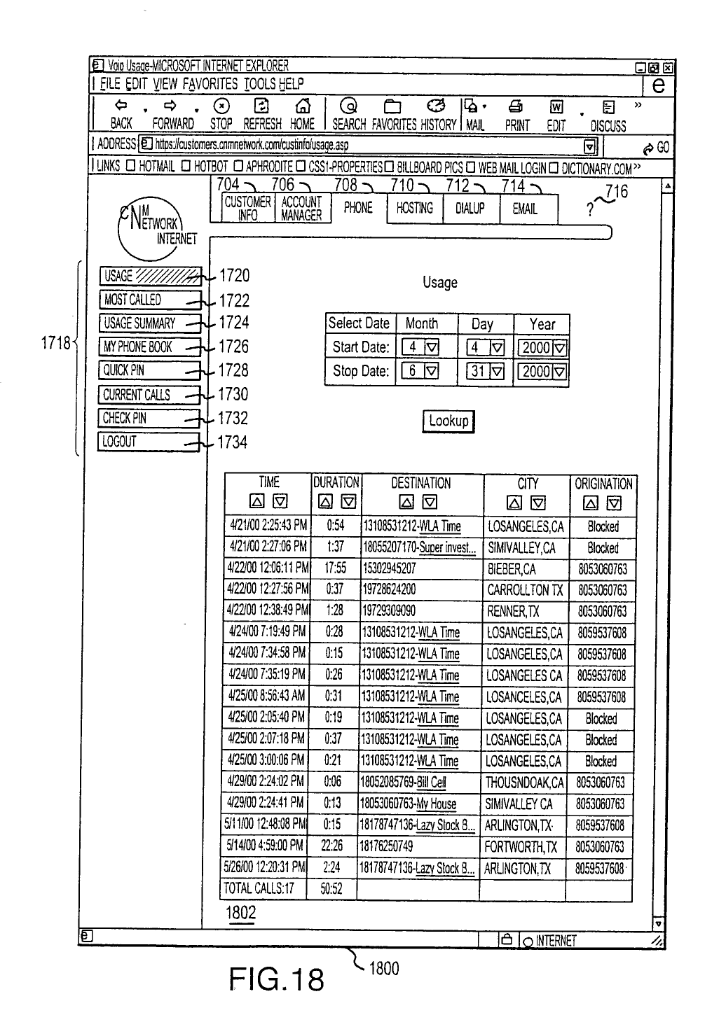

Clicking on Usage select button 1720 causes Usage Web Page 1800 of FIG. 18 to be displayed on customer Web browser 302. Frame 1802 displays information about the individual calls made by the customer, such as time of call, duration of call, destination, destination city, and call origination. The customer can select the start date and stop date for the usage information displayed.

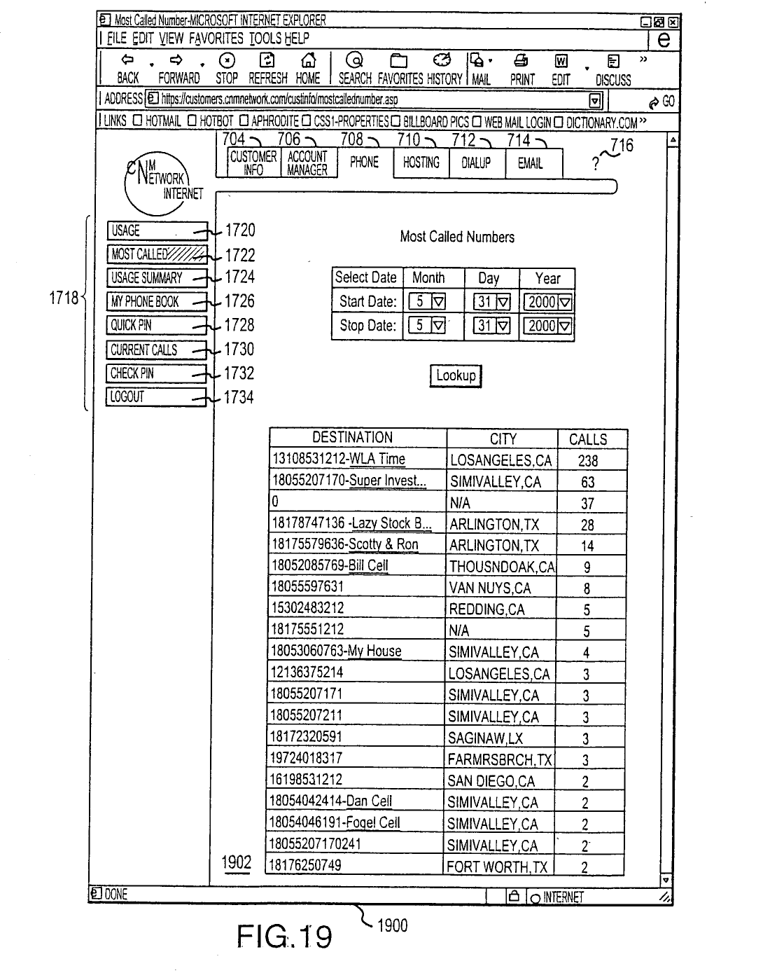

Clicking on Most Called select button 1722 causes Most Called Numbers Web Page 1900 of FIG. 19 to be displayed on customer Web browser 302. Frame 1902 displays information about the most called destinations, destination city, and the number of calls made, listed in descending order. The customer can select the start date and stop date to alter the summary information displayed.

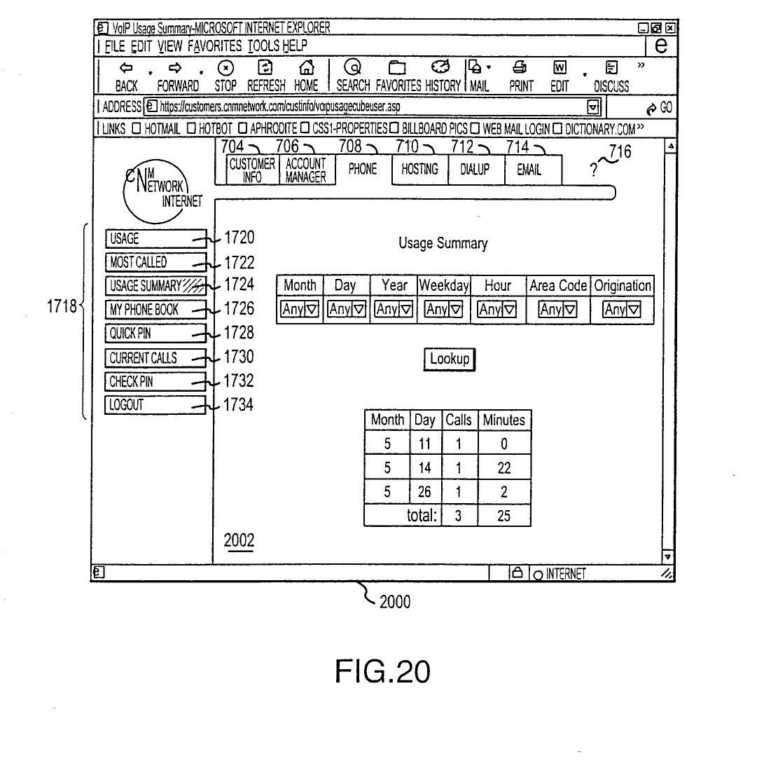

Clicking on Usage Summary select button 1724 causes Usage Summary Web Page 2000 of FIG. 20 to be displayed on customer Web browser 302. Frame 2002 displays summary information about the month, day, calls, and minutes made by the customer based on criteria selected by the customer.

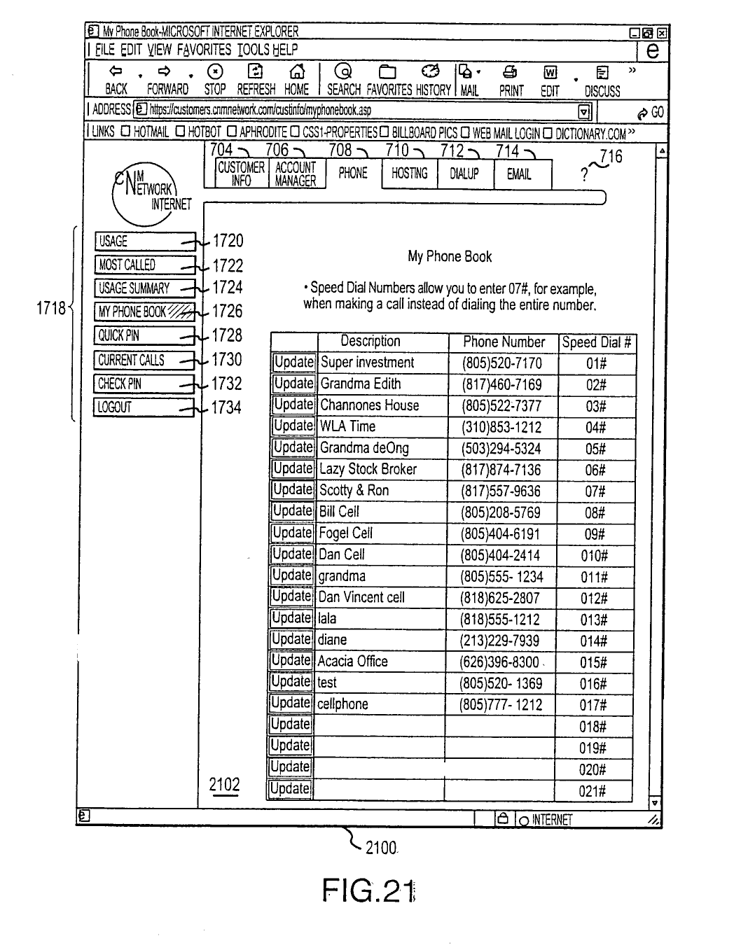

Clicking on My Phone Book select button 1726 causes My Phone Book Web Page 2100 of FIG. 21 to be displayed on customer Web browser 302. Frame 2102 displays the current phone numbers and description that have been entered by the customer. A speed dial number is automatically assigned to each entry. To add an entry, the customer clicks in a blank cell in the table and types-in the information. Entries may be deleted by clicking in the cell and pressing the delete button on the customer's keyboard.

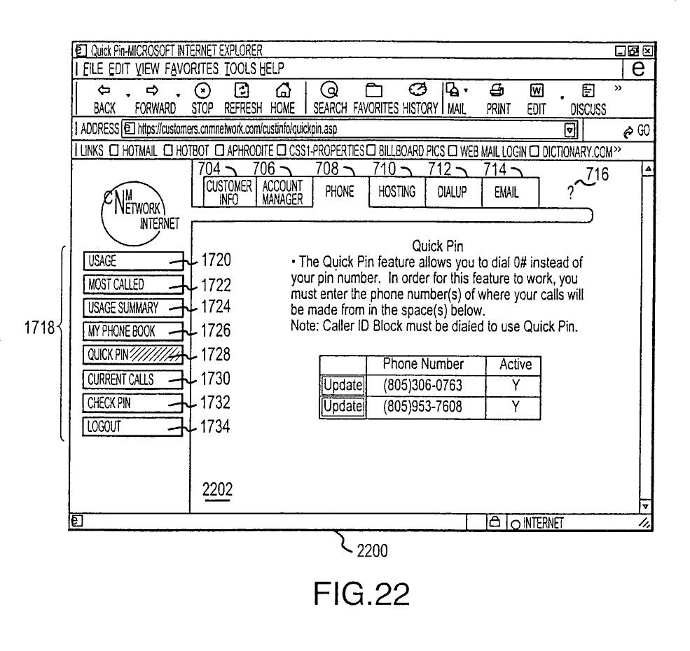

Clicking on Quick PIN select button 1728 causes Quick PIN Web Page 2200 of FIG. 22 to be displayed on customer Web browser 302. Frame 2202 displays information that allows the customer to enter information regarding the phone number(s) where the customer will make calls from. This enables the customer to only have to dial 0# instead of the customer's entire PIN number when making a call.

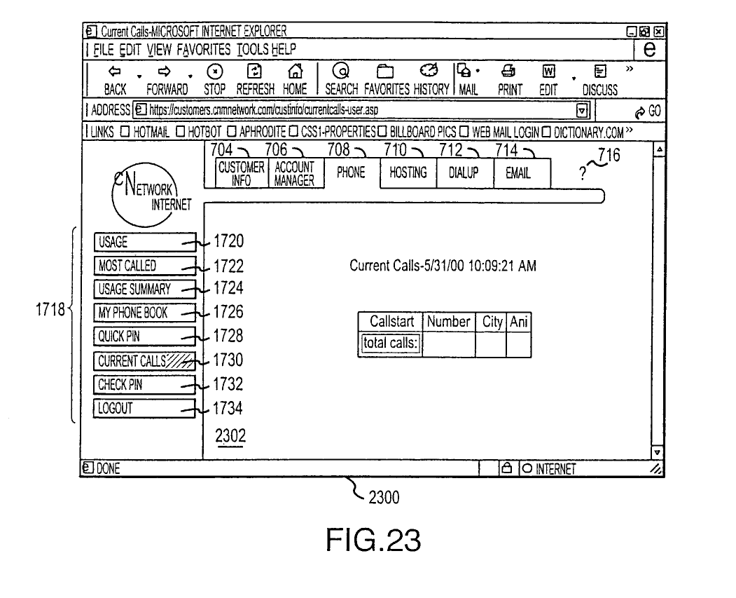

Clicking on Current Calls select button 1730 causes Current Calls Web Page 2300 of FIG. 23 to be displayed on customer Web browser 302. Frame 2302 displays a tracking window that displays all calls in real time that are currently in progress. The date and time of the start of the call, the number called, the city, and the billing number of the originating party (ANI) are displayed.

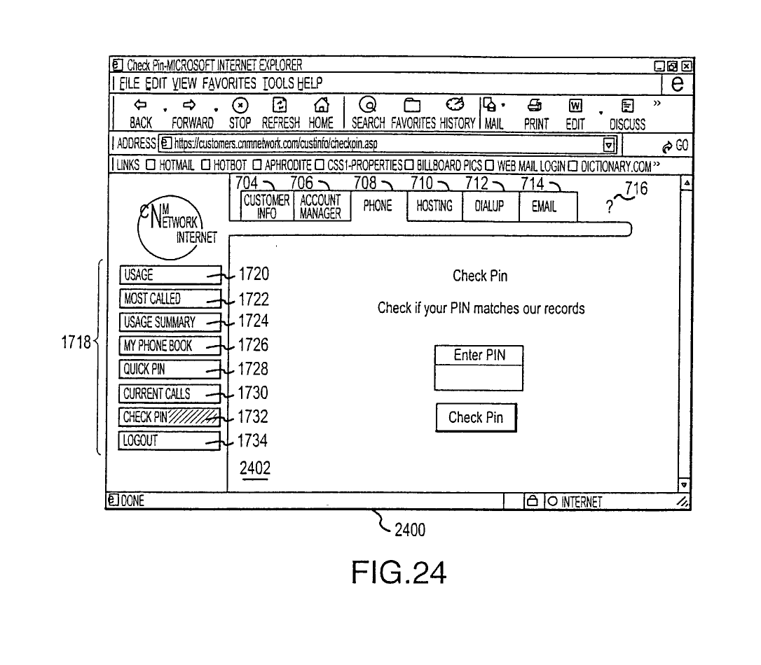

Clicking on Check PIN select button 1732 causes Check PIN Web Page 2400 of FIG. 24 to be displayed on customer Web browser 302. Frame 2402 displays a box in which the customer can enter their PIN number and verify if it matches the VoIP private network records. Clicking on Logout select button 1734 will log the customer out of the account information portion of the Web Site and return the customer to the home page.

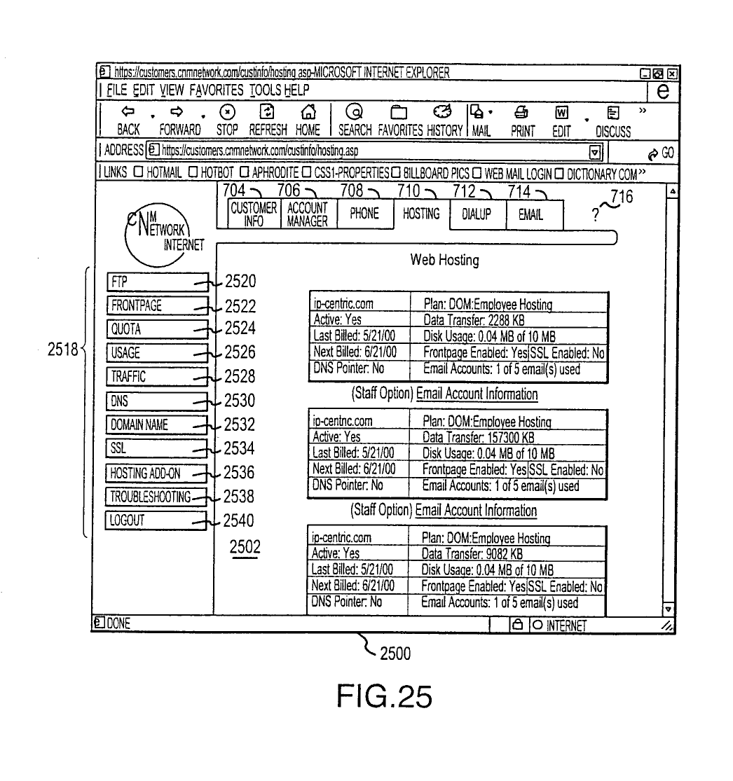

Selecting Hosting tab 710 causes Web Hosting Web Page 2500 of FIG. 25 to be displayed on customer Web browser 302. Frame 2502 displays information about the customer's Web Sites hosted by the VoIP private network. Hosting tab 710 gives the customer access to several select buttons 2518. The customer may click on any of the select buttons 2518 to access the features represented by each select button.

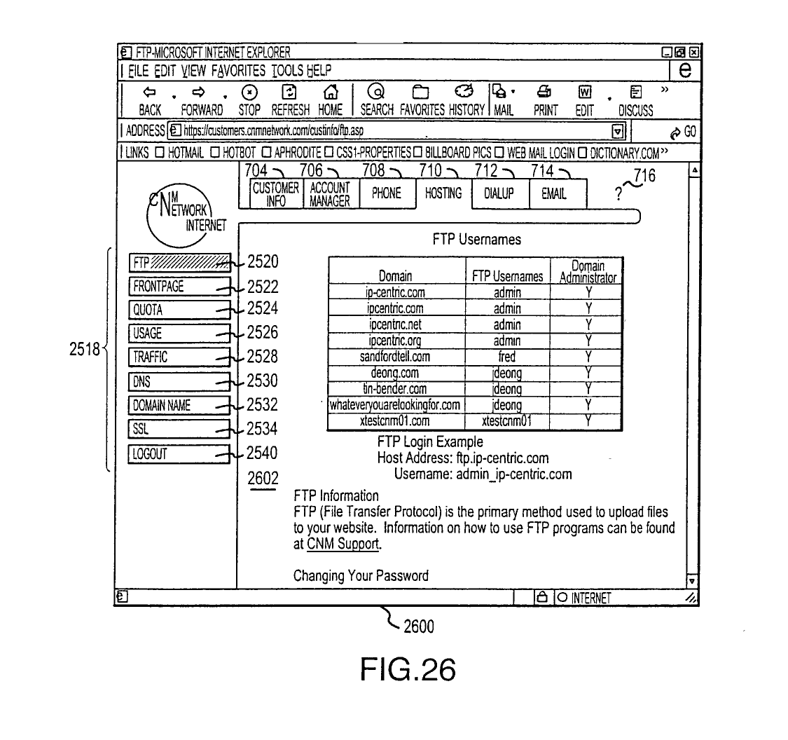

Clicking on FTP select button 2520 causes FTP Usernames Web Page 2600 of FIG. 26 to be displayed on customer Web browser 302. Frame 2602 displays a table that allows a customer to manage FTP (File Transfer Protocol) access for their domains to enable or configure file sharing services.

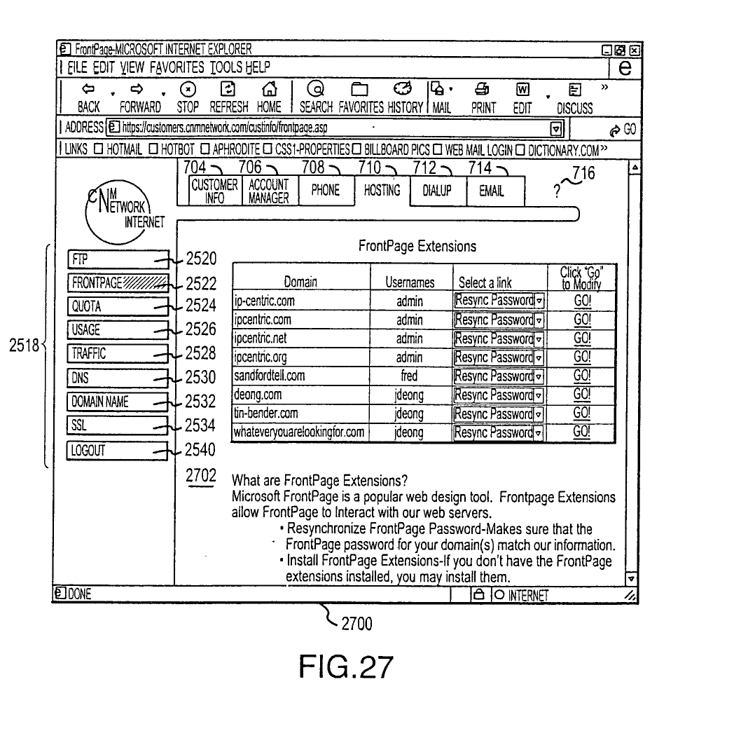

Clicking on FrontPage select button 2522 causes FrontPage Extensions Web Page 2700 of FIG. 27 to be displayed on customer Web browser 302. Frame 2702 displays a table that allows a customer to manage Microsoft FrontPage access to enable or configure Web publishing services.

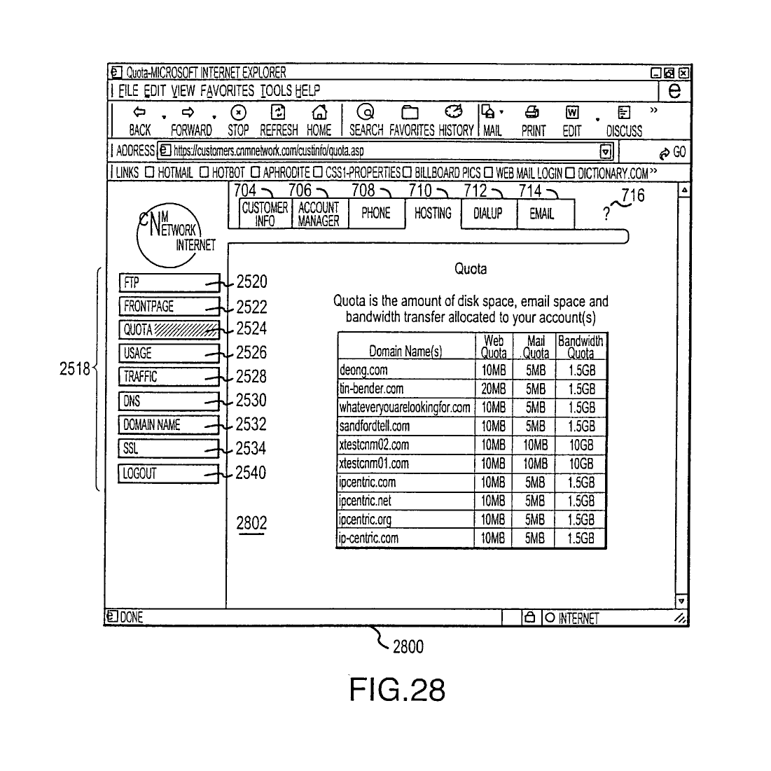

Clicking on Quota select button 2524 causes Quota Web Page 2800 of FIG. 28 to be displayed on customer Web browser 302. Frame 2802 displays a table that allows a customer to manage the amount of disk space, email space, and bandwidth transfer allocated to the customer's accounts.

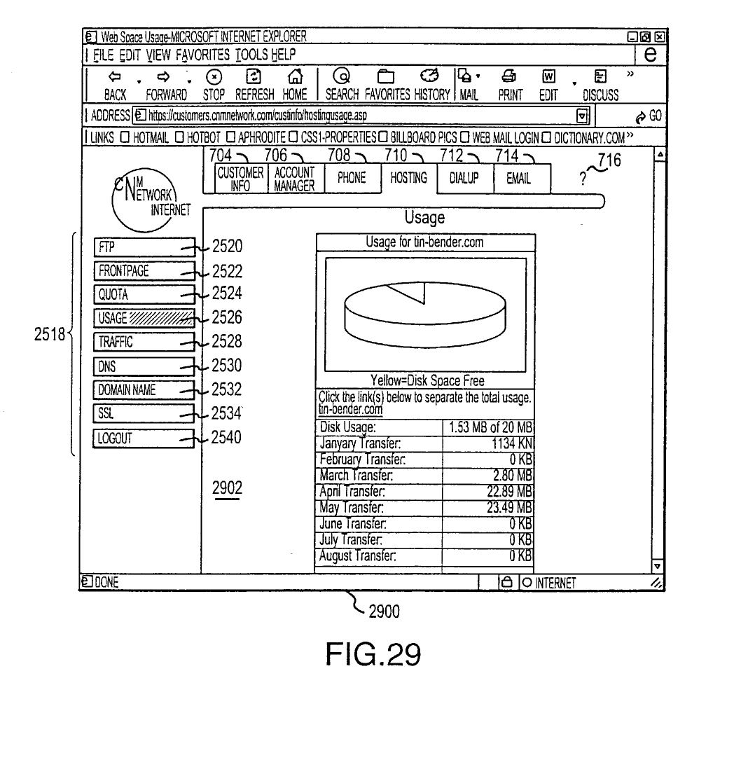

Clicking on Usage select button 2526 causes Usage Web Page 2900 of FIG. 29 to be displayed on customer Web browser 302. Frame 2902 displays aggregate reports on service usage.

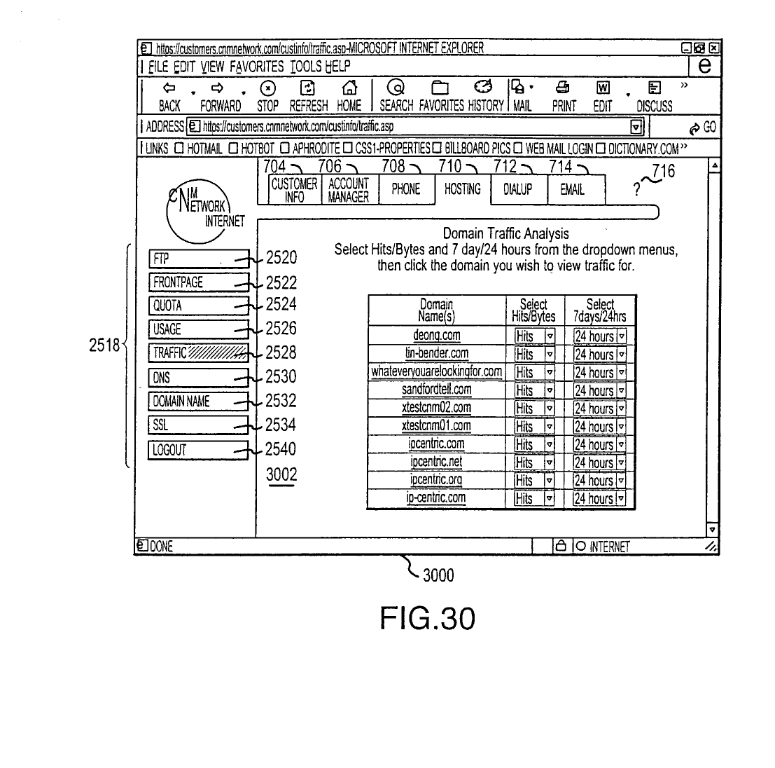

Clicking on Traffic select button 2528 causes Domain Traffic Analysis Web Page 3000 of FIG. 30 to be displayed on customer Web browser 302. Frame 3002 displays detailed reports on accesses to the customers various Web sites.

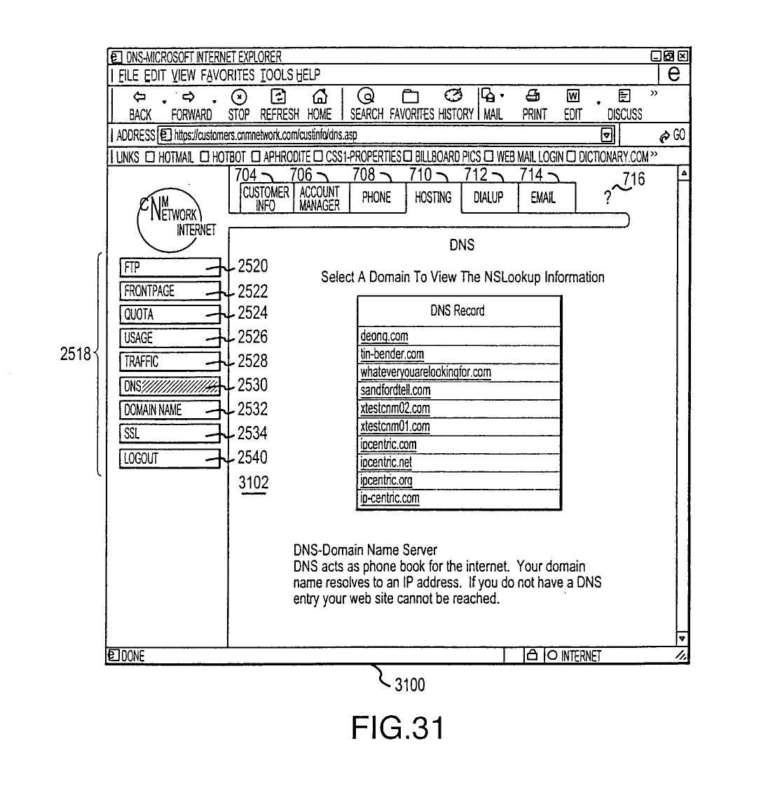

Clicking on DNS select button 2530 causes DNS Web Page 3100 of FIG. 31 to be displayed on customer Web browser 302. Frame 3102 displays the DNS (Domain Name Service) entries for the customer's domains.

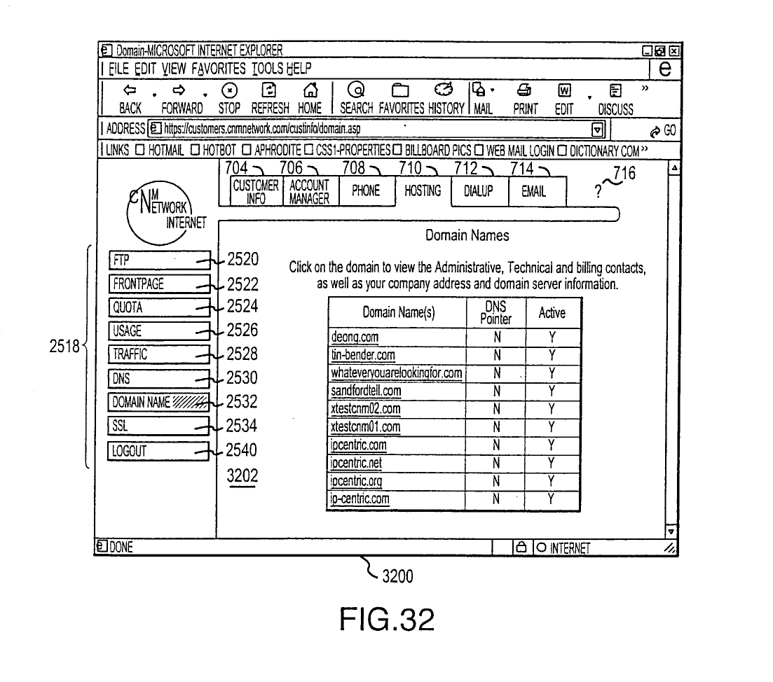

Clicking on Domain Name select button 2532 causes Domain Names Web Page 3200 of FIG. 32 to be displayed on customer Web browser 302. Frame 3202 displays domain registry information from the Internet registrar.

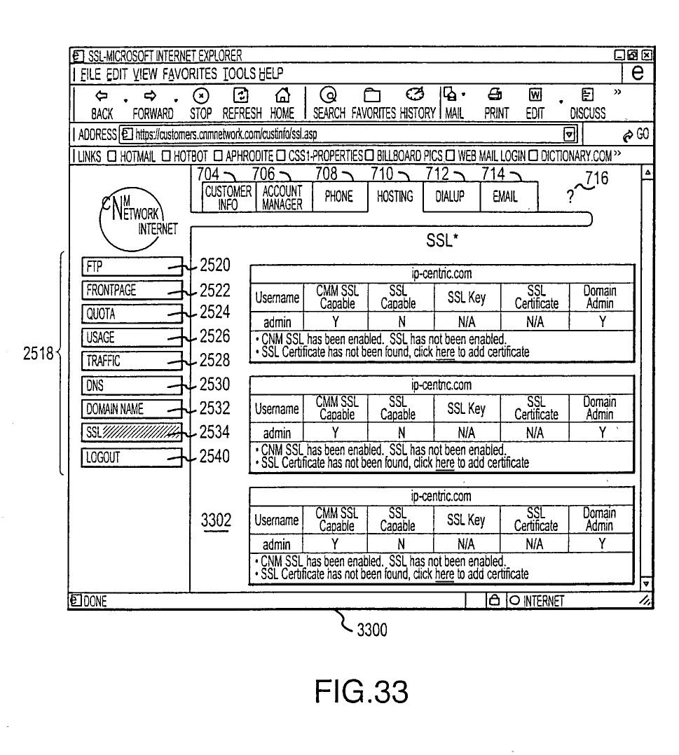

Clicking on SSL select button 2534 causes SSL Web Page 3300 of FIG. 33 to be displayed on customer Web browser 302. Frame 3302 displays SSL (Secure Socket Layer) Web site information allowing the customer to enable or configure a Web site to communicate securely with customers. Clicking on Logout select button 2540 will log the customer out of the account information portion of the Web Site and return the customer to the home page.

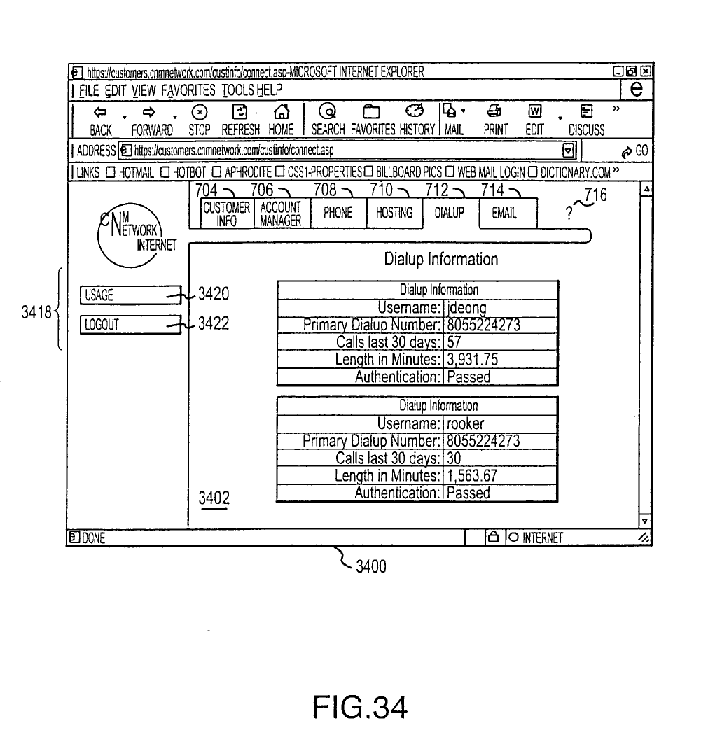

Selecting Dialup tab 712 causes Dialup Information Web Page 3400 of FIG. 34 to be displayed on customer Web browser 302. Frame 3402 displays dialup information by user name, showing the primary dialup number, total calls in the last 30 days, length in minutes of those calls, etc. for each user name. Dialup tab 712 gives the customer access to several select buttons 3418. The customer may click on any of the select buttons 3418 to access the features represented by each select button.

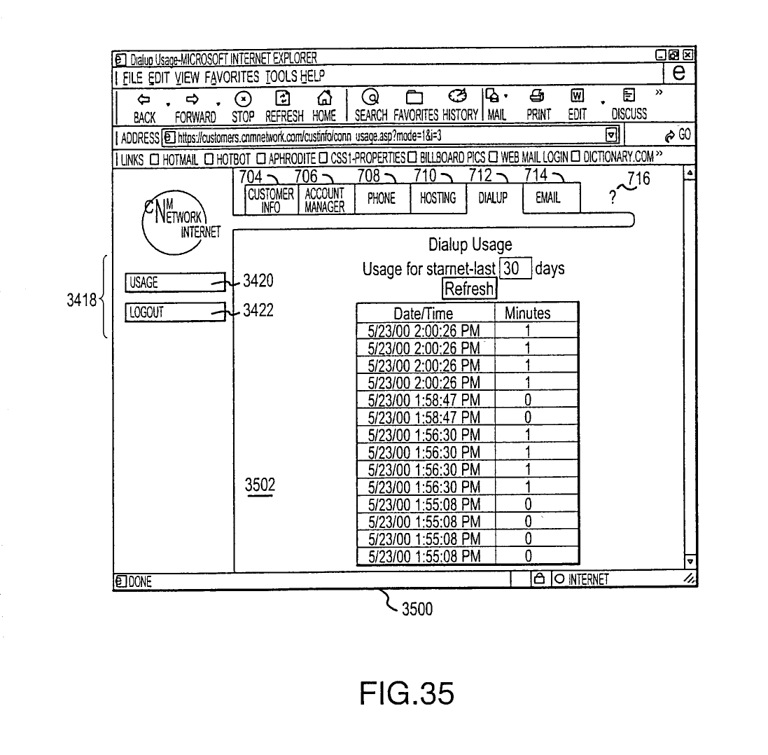

Clicking on Usage select button 3420 causes Dialup Usage Web Page 3500 of FIG. 35 to be displayed on customer Web browser 302. Frame 3502 displays aggregate reports on usage. Clicking on Logout select button 3422 will log the customer out of the account information portion of the Web Site and return the customer to the home page.

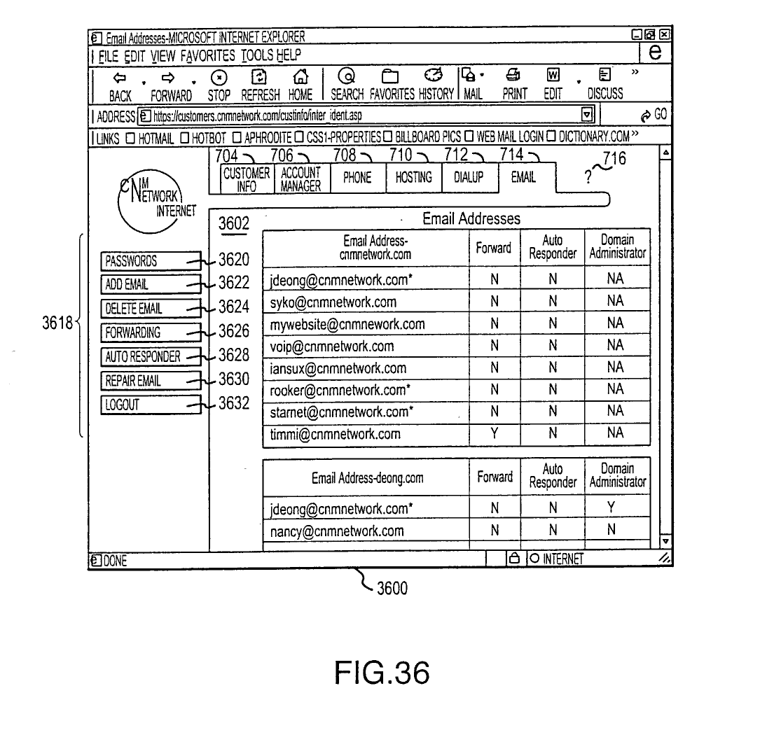

Selecting Email tab 714 causes Email Addresses Web Page 3600 of FIG. 36 to be displayed on customer Web browser 302. Frame 3602 displays the email addresses currently stored in the VoIP private network that have been entered by the customer. The email addresses may be grouped by common domain name. Email tab 714 gives the customer access to several select buttons 3618. The customer may click on any of the select buttons 3618 to access the features represented by each select button.

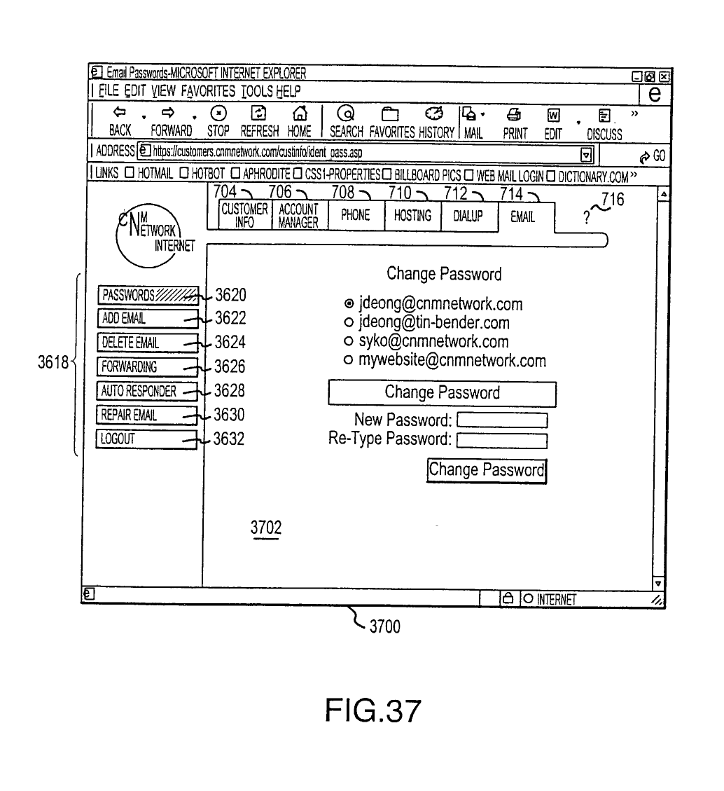

Clicking on Passwords select button 3620 causes Change Password Web Page 3700 of FIG. 37 to be displayed on customer Web browser 302. Frame 3702 displays the customer's email account names and allows the customer to change the password on any of the email accounts.

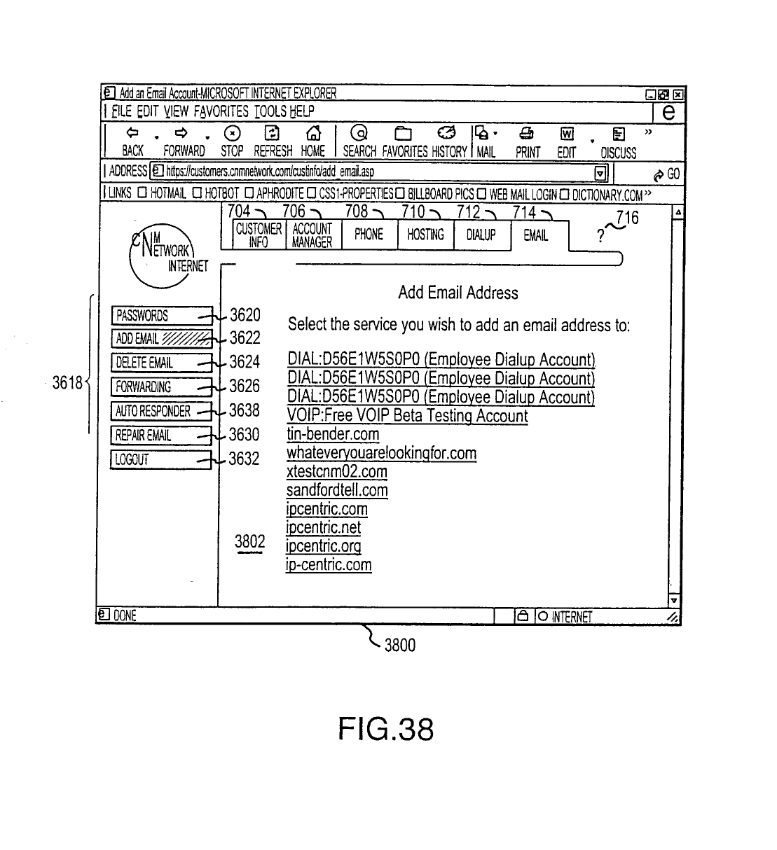

Clicking on Add Email select button 3622 causes Add Email Address Web Page 3800 of FIG. 38 to be displayed on customer Web browser 302. Frame 3802 displays the types of services the customer may add an email address to.

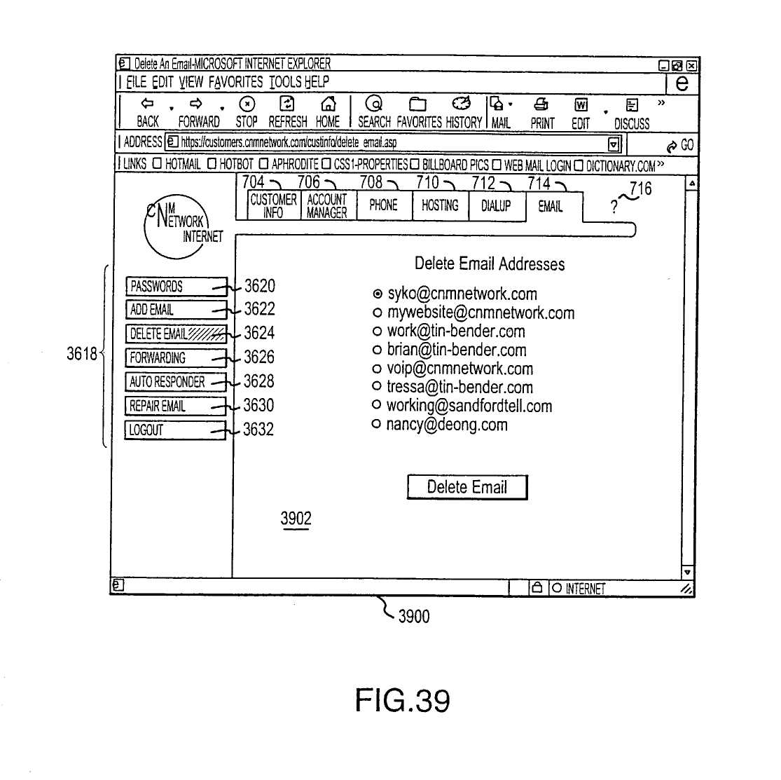

Clicking on Delete Email select button 3624 causes Delete Email Addresses Web Page 3900 of FIG. 39 to be displayed on customer Web browser 302. Frame 3902 displays a list of the customer's current email accounts and allows the customer to select one or more email accounts to delete.

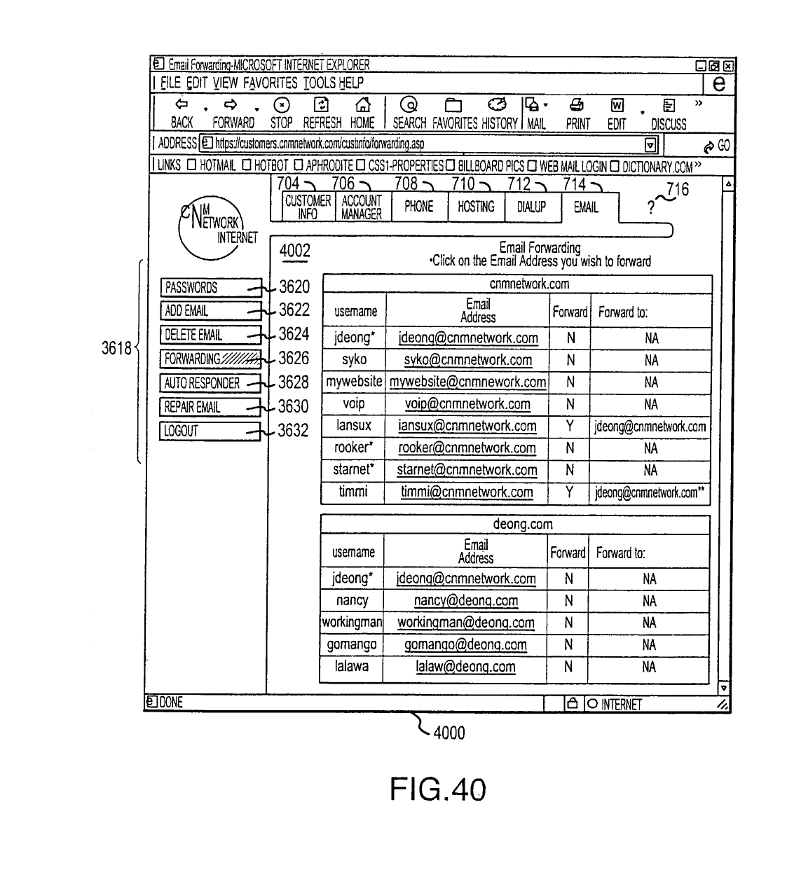

Clicking on Forwarding select button 3626 causes Email Forwarding Web Page 4000 of FIG. 40 to be displayed on customer Web browser 302. Frame 4002 displays email information by domain, and allows the customer to configure an email address to forward to another email address.

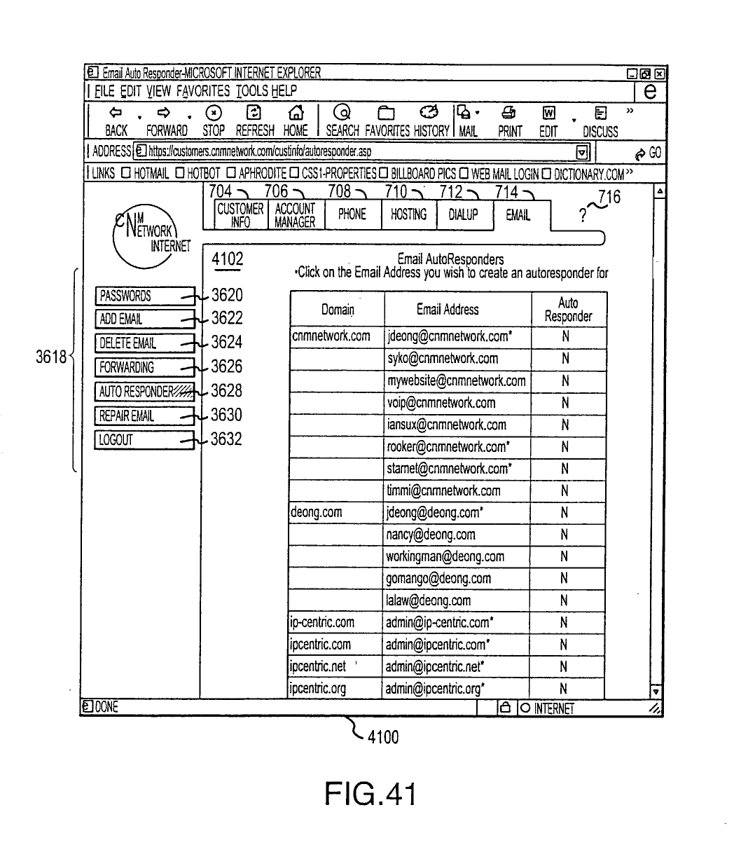

Clicking on Auto Responder select button 3628 causes Email Auto Responders Web Page 4100 of FIG. 41 to be displayed on customer Web browser 302. Frame 4102 displays a list of the customer's email addresses and allows the customer to configure an email address to send a predefined message to the original sender.

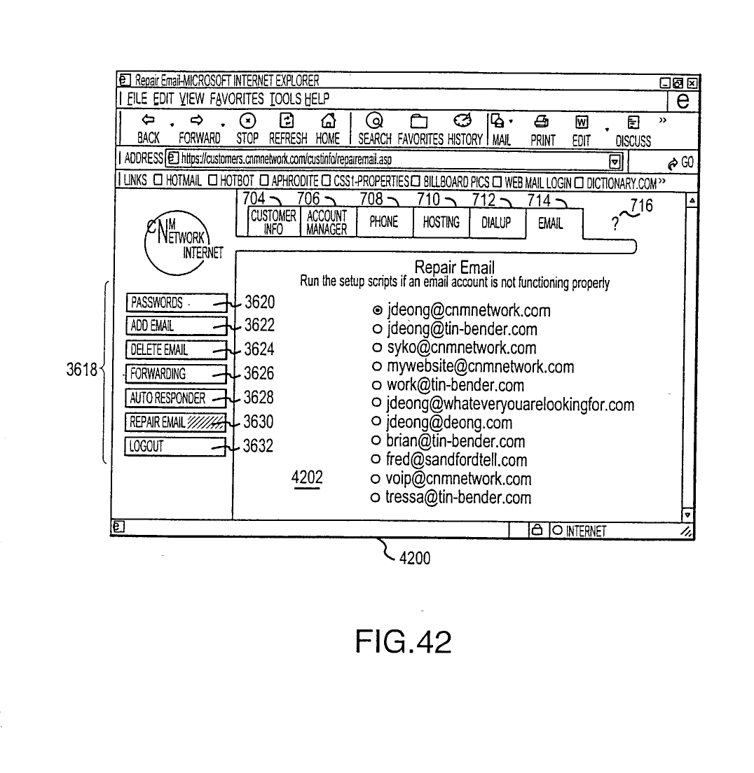

Clicking on Repair Email select button 3630 causes Repair Email Web Page 4200 of FIG. 42 to be displayed on customer Web browser 302. Frame 4202 displays a list of the customer's email addresses and allows the customer to attempt to fix a problem with an email account. Clicking on Logout select button 3632 will log the customer out of the account information portion of the Web Site and return the customer to the home page.

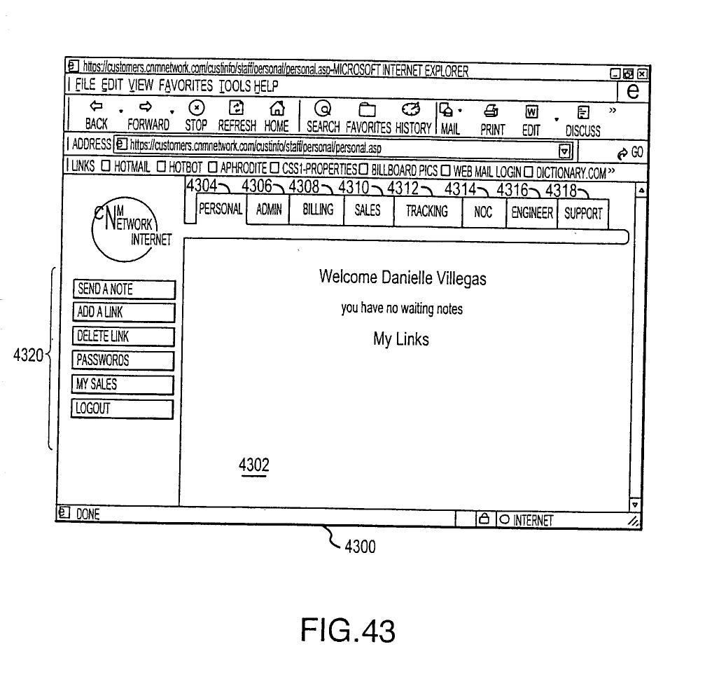

FIGS. 43 to 58 are screen shot representations of Web pages accessible to VoIP network personnel, also referred to as “staff members”, through a Web Browser which demonstrate the management interface of the present invention. In addition, staff members have full access to all of the Web pages that a customer can access from public website 306.

Referring now to FIGS. 43 to 58, staff Web Browser 316 may be Microsoft Internet Explorer or Netscape Navigator or any other appropriate Web Browser. Microsoft Internet Explorer is the Web Browser shown in FIGS. 43 to 58. Staff members are provided with a browser that already has the staff login page listed in their bookmarks. The staff login page only allows access from certain predetermined network addresses. On the staff login page a request is made for the staff member to enter a user name and password. Authorization/interface module 308 compares the user entry with the staff database entries and allows access only if the user name and password match an entry in database 312. Private Web Site 318 is run under a HTPPS (Hypertext Transfer Protocol Secure) server 128 bit SSL (Secure Socket Layer), which means the user names and passwords are not passed in clear text across the network as is the case with normal HTTP.

Each page in the system has security checks which check first to ensure that the request is coming in on a secure server. If the request is not on a secure server the staff member is redirected to the secure server. The second security check is the staff members network address. This ensures that access can not be made from unwanted networks. The third security check is on a page basis. Each page has a security check which checks the staff members security profile and ensures that the staff member has the required security. If security requirements are not met the staff member is not allowed to use the page.

If the user name and password are valid, and all the security requirements are met, Personal Web Page 4300 of FIG. 43 is retrieved from private Web Site 318 and returned to staff Web Browser 316 for display. Frame 4302 displays the staff member's name and a message indicating if there are any waiting notes for the staff member. Clicking on “My Links” displayed in frame 4302 accesses a simple bookmark function for the staff member. If the staff member uses a particular Web Site frequently, the staff member can enter that Web Site's address with a personalized description into the “My Links” function.

Staff Options tabs 4304, 4306, 4308, 4310, 4312, 4314, 4316, and 4318 give the staff member access to various VoIP private network functionality. In FIG. 43 Personal tab 4304 is active, giving the staff member access to several select buttons 4320. The staff member may click on any of the select buttons 4320 to access the feature represented by the particular select button.

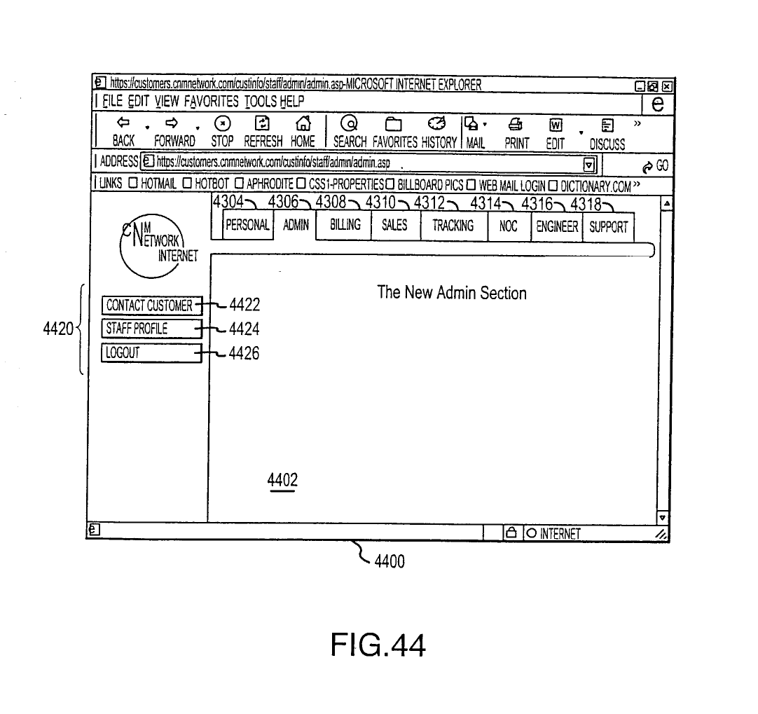

Selecting Admin tab 4306 causes Admin Web Page 4400 of FIG. 44 to be displayed on staff Web browser 316. Admin tab 4306 gives the staff member access to several select buttons 4420. Clicking on Contact Customer select button 4422 accesses a simple query tool that allows staff members to create dynamic customer contact lists. For example, if a staff member in marketing wanted to contact all customers who already own a dialup account in order try to sell these customers new services, the staff member can access the Contact Customer tool and create a contact list of all existing dialup customers.

This tool can also be used to notify customers of service outages, upgrades, etc. For example, if a VoIP private network access number changed or was out of service, a staff member could use the Contact Customer tool to query all the customers who use that access number and inform them of the service issues.

Clicking on Staff Profile select button 4424 accesses a manager function to manage the staff members of the system. Clicking on Logout select button 4426 will log the staff member out of private Web Site 318 and return the staff member to the staff login page.

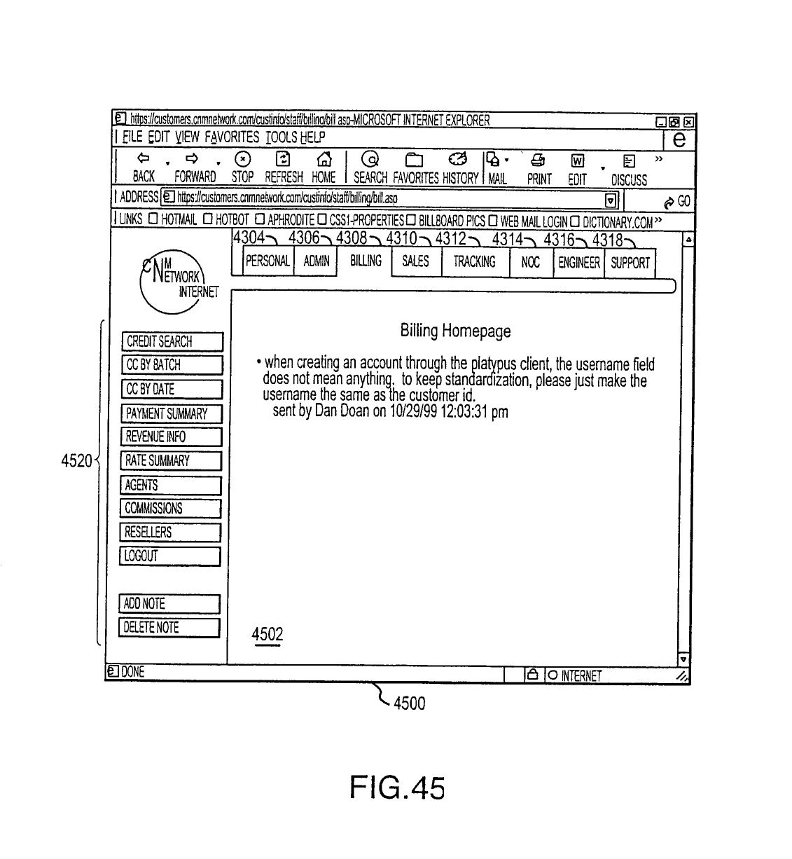

Selecting Billing tab 4308 causes Billing Homepage Web Page 4500 of FIG. 45 to be displayed on staff Web browser 316. Frame 4502 displays any recent notes posted by staff members pertinent to this Web page. Billing tab 4308 gives the staff member access to several select buttons 4520. The staff member may click on any of the select buttons 4520 to access the features represented by the select button.

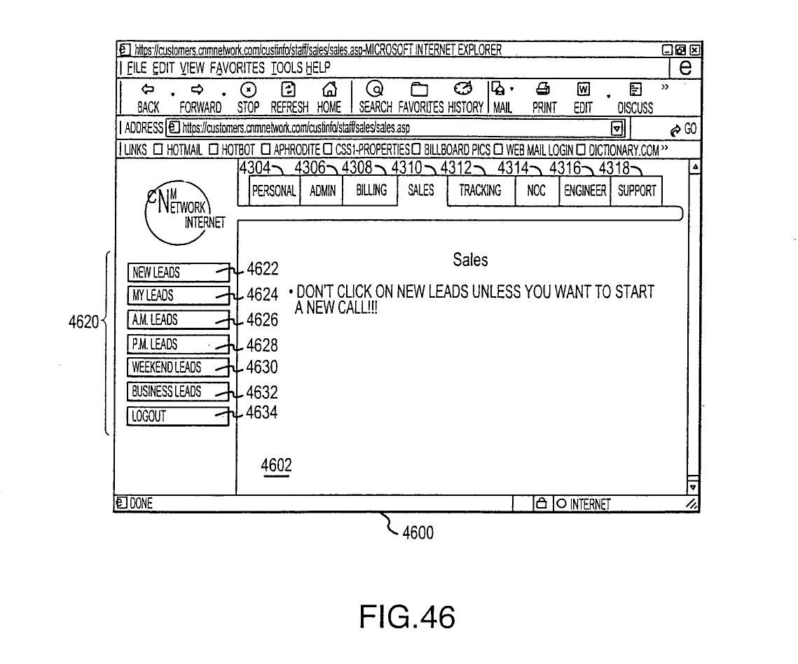

Selecting Sales tab 4310 causes Sales Web Page 4600 of FIG. 46 to be displayed on staff Web browser 316. Frame 4602 displays any recent notes posted by staff members pertinent to this Web page. Sales tab 4310 gives the staff member access to several select buttons 4620. The staff member may click on any of the select buttons 4620 to access the features represented by the select button.

Sales Web Page 4600 is an outbound sales lead tool. Purchased contact lead lists are imported into database 312. When a sales staff member is ready to start selling, the sales staff member clicks on New Leads select button 4622 to access a new lead. This brings the next available contact lead onto the Web page and allows the staff member to contact the lead. If the lead agrees to service, the lead information is posted to the signup forms and the lead is added into the VoIP private network. If the lead does not agree or is not available to be contacted, the lead is marked appropriately and goes back into the lead system.

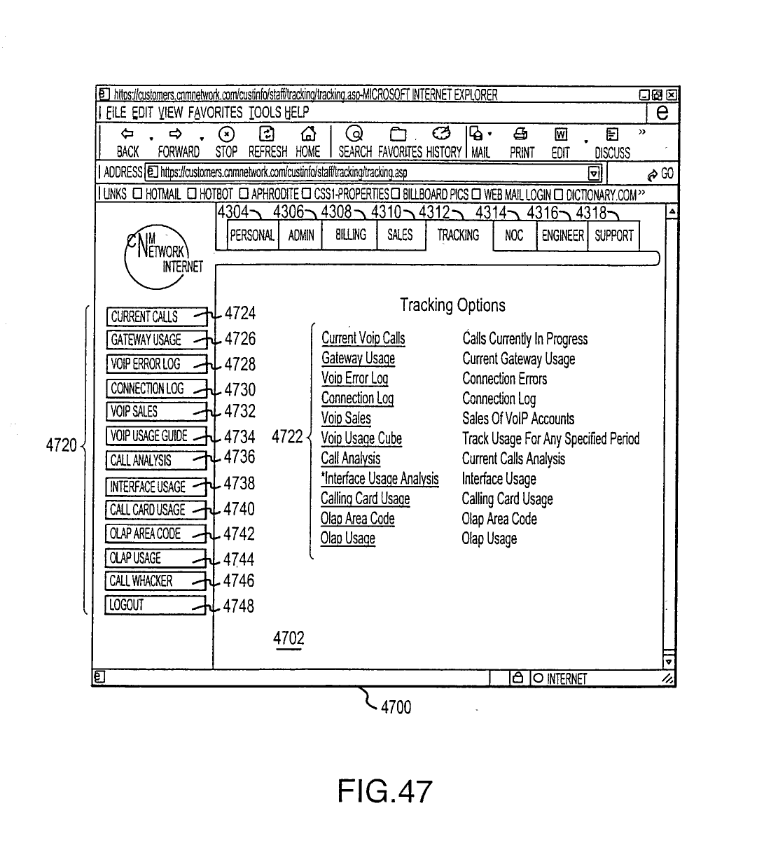

Selecting Tracking tab 4312 causes Tracking Options Web Page 4700 of FIG. 47 to be displayed on staff Web browser 316. Frame 4702 displays several links 4722 of tracking options which correspond to several select buttons 4720. The staff member may click on any of the links 4722 or select buttons 4720 to access the features represented by the link or select button.

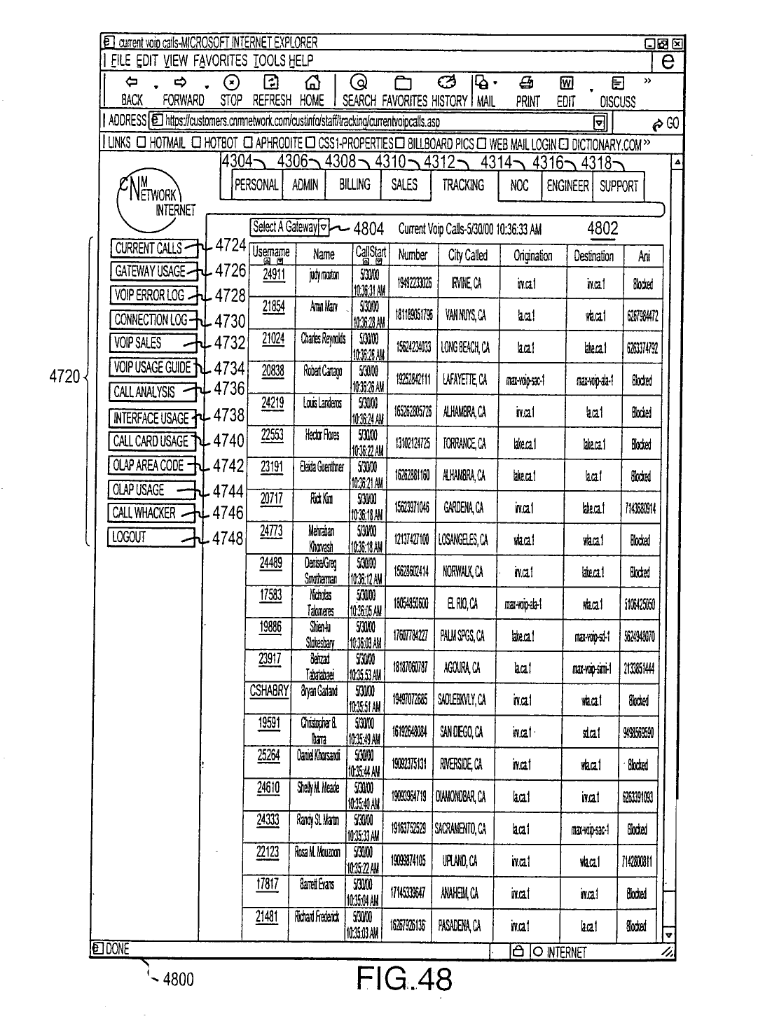

Clicking on Current Calls select button 4724, or the corresponding link, causes Current VoIP Calls Web Page 4800 of FIG. 48 to be displayed on staff Web browser 316. Frame 4802 displays all real time calls that are in progress on all gateways in the VoIP private network. Select A Gateway pull down list 4804 allows the staff member to view all real time calls that are in progress on the gateway selected.

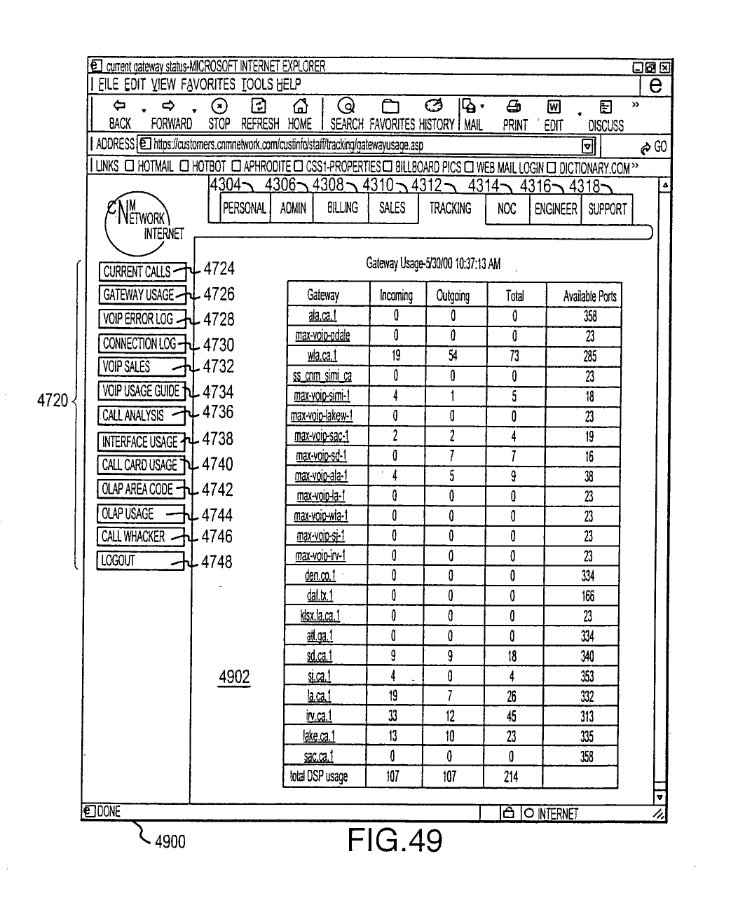

Clicking on Gateway Usage select button 4726 or the corresponding link causes Gateway Usage Web Page 4900 of FIG. 49 to be displayed on staff Web browser 316. Frame 4902 displays information about each gateway in the VoIP private network.

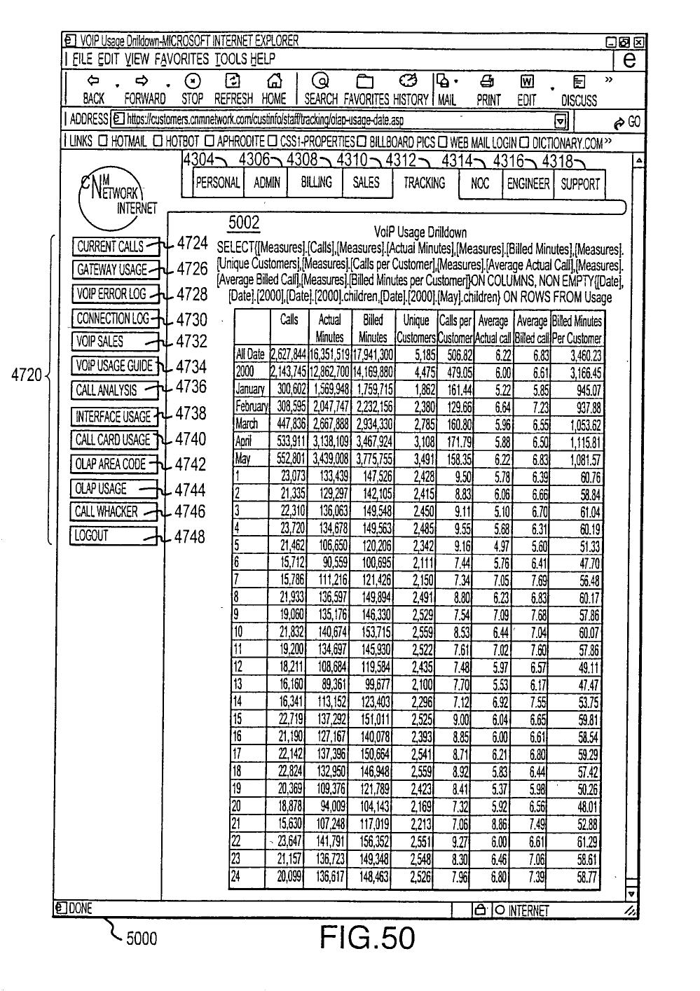

Clicking on VoIP Usage Cube select button 4734 or the corresponding link causes VoIP Usage Drilldown Web Page 5000 of FIG. 50 to be displayed on staff Web browser 316. Frame 5002 displays summary usage information based upon staff member entered criteria.

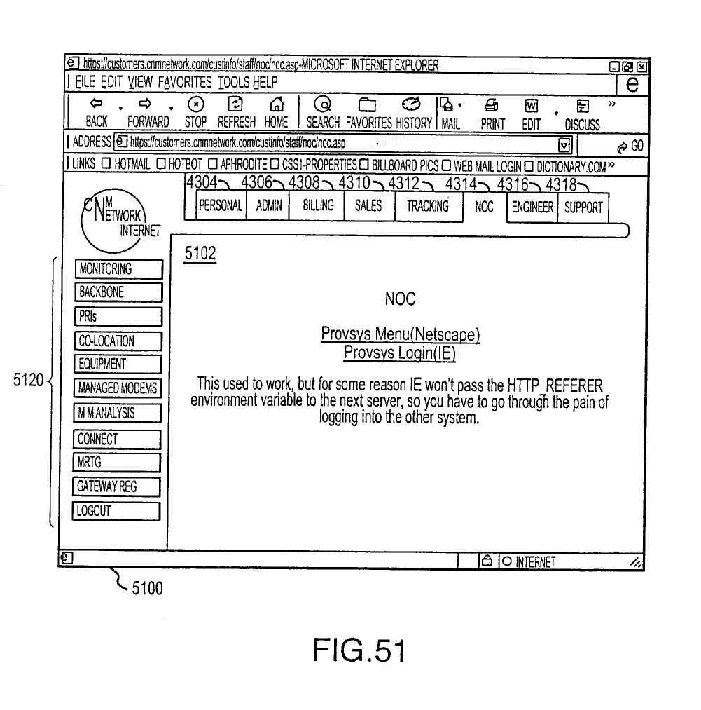

Selecting NOC tab 4314 causes Network Operations Center Web Page 5100 of FIG. 51 to be displayed on staff Web browser 316. Frame 5102 displays a virtual “frame” encapsulating access to various other internal monitoring systems. It provides a single convenient method of accessing multiple heterogeneous monitoring systems through a single and consistent interface. NOC tab 4314 gives the staff member access to several select buttons 5120. The staff member may click on any of-the select buttons 5120 to access the features represented by the select button.

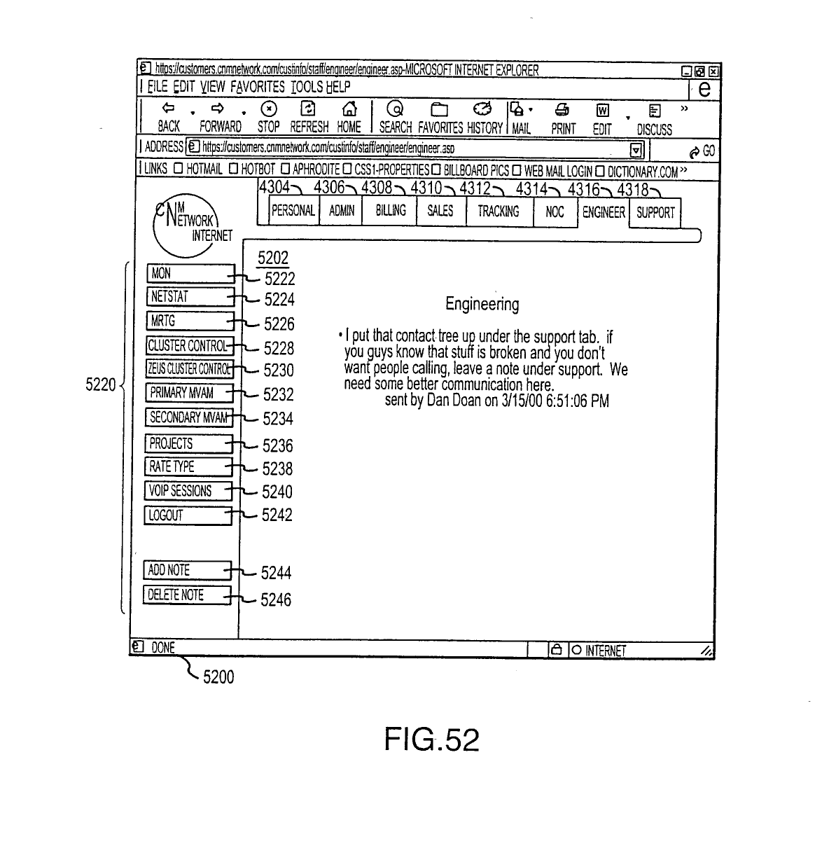

Selecting Engineer tab 4316 causes Engineering Web Page 5200 of FIG. 52 to be displayed on staff Web browser 316. Frame 5202 displays notes posted by staff members pertinent to this Web page. Engineer tab 4316 gives the staff member access to several select buttons 5220. The staff member may click on any of the select buttons 5220 to access the features represented by the select button.

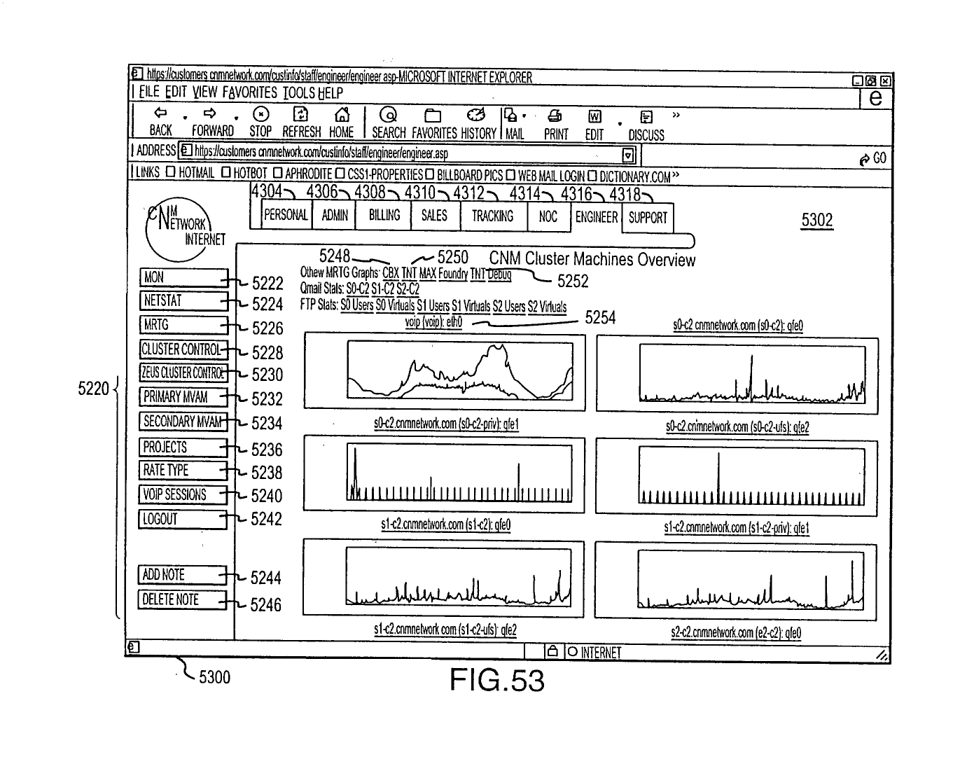

Clicking on Mon select button 5222 allows the staff member to set the configuration for SiteScope, a monitoring and alerting system (not shown). Clicking on Netstat select button 5224 gives the staff member access to WAN/Internet peering point monitoring (not shown). Clicking on MRTG select button 5226 causes Cluster Machines Overview Web Page 5300 of FIG. 53 to be displayed on staff Web browser 316. Frame 5302 displays several Multi Router Tracking Graphs (“MRTG”). MRTG is a freeware graphing tool that VoIP private network data is fed into in order to create various tracking graphs. The MRTG graphs show information about the VoIP private network's clustered internet servers. These servers provide email, ftp (File Transfer Protocol), dns (Domain Naming System), Web hosting, and other related services.

Clicking on Cluster Control select button 5228 gives the staff member access to a freeware Web based tool called Cluster Control to manage the clustered services (not shown). The internet services of the VoIP private network are designed to run in a clustered environment, but staff members need to be able to start, stop, and configure these services on separate machines. For example, instead of logging on to each server in the cluster to restart the email service, the staff member simply clicks on the “restart clustered email” option (not shown) and the Cluster Control tool contacts each server and instructs each server to restart email service.

Clicking on Zeus Cluster Control select button 5230 gives the staff member access to the control mechanism, called Zeus Cluster Control (not shown), provided by the VoIP private network's Web server software provider. Zeus Cluster Control is just framed into the VoIP private network's interface.

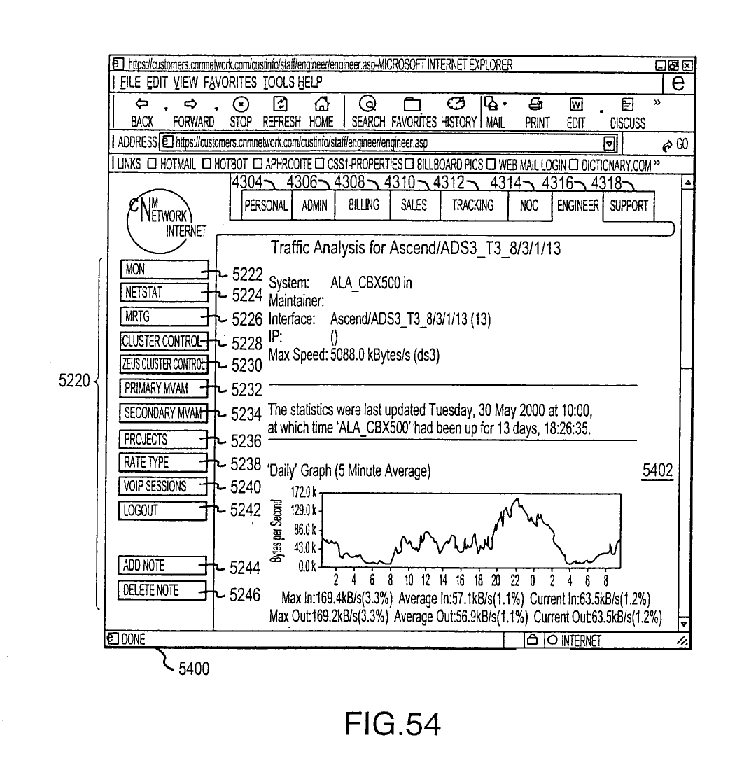

Clicking on CBX hyperlink 5248 causes Traffic Analysis Web Page 5400 of FIG. 54 to be displayed on staff Web browser 316. Frame 5402 displays another MRTG graph showing information on a WAN switch, such as WAN switch 216/222. All network devices are sampled at five minute intervals to retrieve operational data. For the WAN switches, backbone circuit use is sampled.

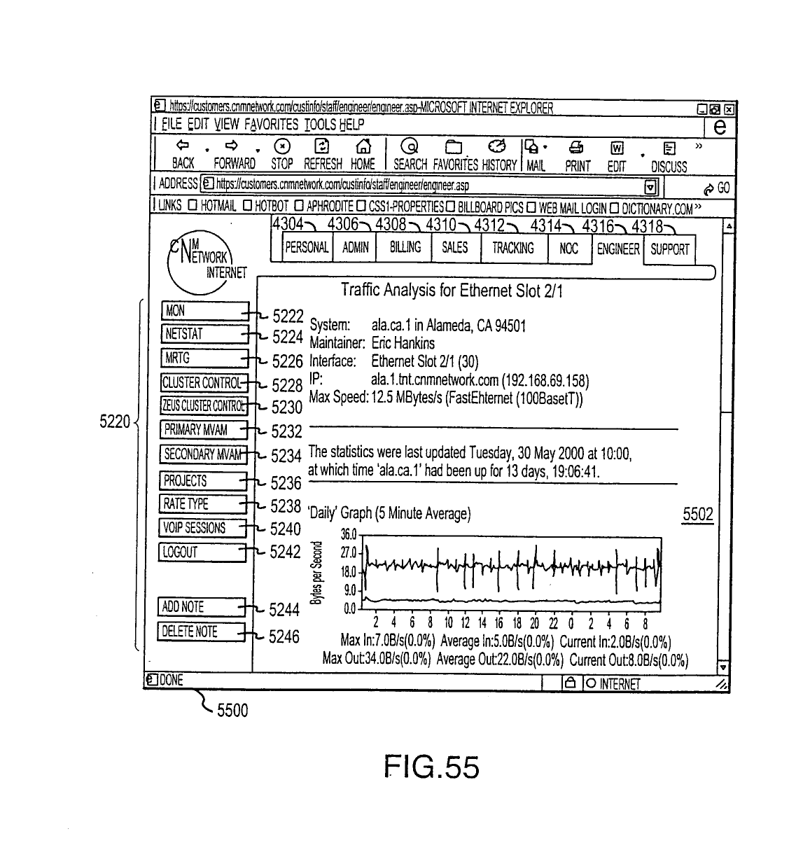

Clicking on TNT hyperlink 5250 causes Traffic Analysis Web Page 5500 of FIG. 55 to be displayed on staff Web browser 316. Frame 5502 displays another MRTG graph showing information on an Ethernet Slot for a particular gateway. The operational performance of all pertinent systems of the VoIP private network are sampled and graphed and the cost components thereof.

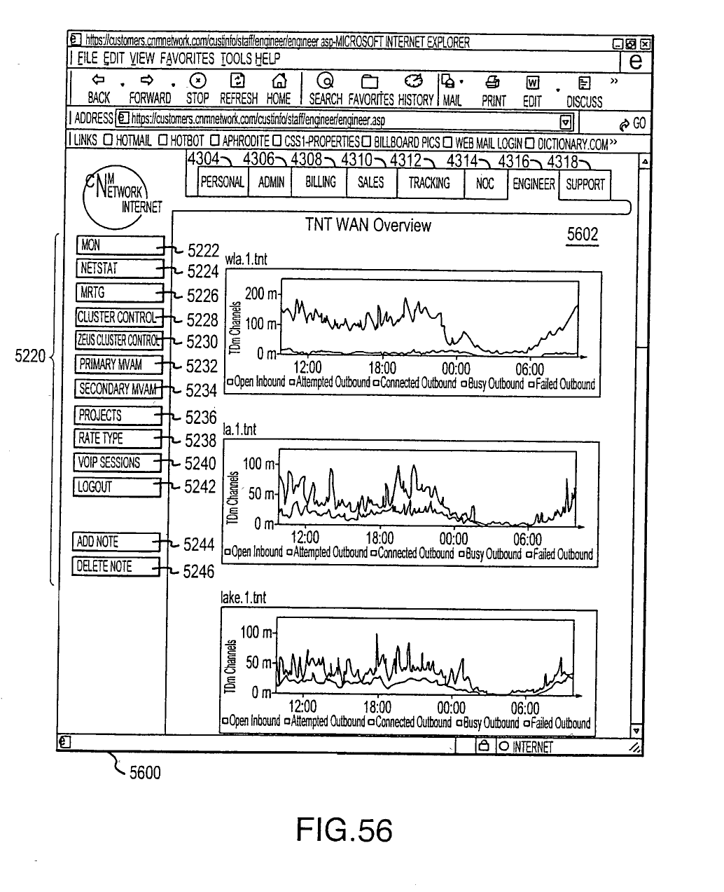

Clicking on TNT Debug hyperlink 5252 causes TNT WAN Overview Web Page 5600 of FIG. 56 to be displayed on staff Web browser 316. Frame 5602 displays another MRTG like function. The VoIP private network has internally developed scripts that go out and query the edge gateways, such as edge gateways 212/218, for PSTN specific call traffic information. Such information includes number of attempted outbound calls, number of attempted inbound calls, number of completed outbound calls, number of failed outbound attempts, and number of busy outbound attempts. This lets the engineer view performance data from a centralized location and is helpful with troubleshooting and resource management.

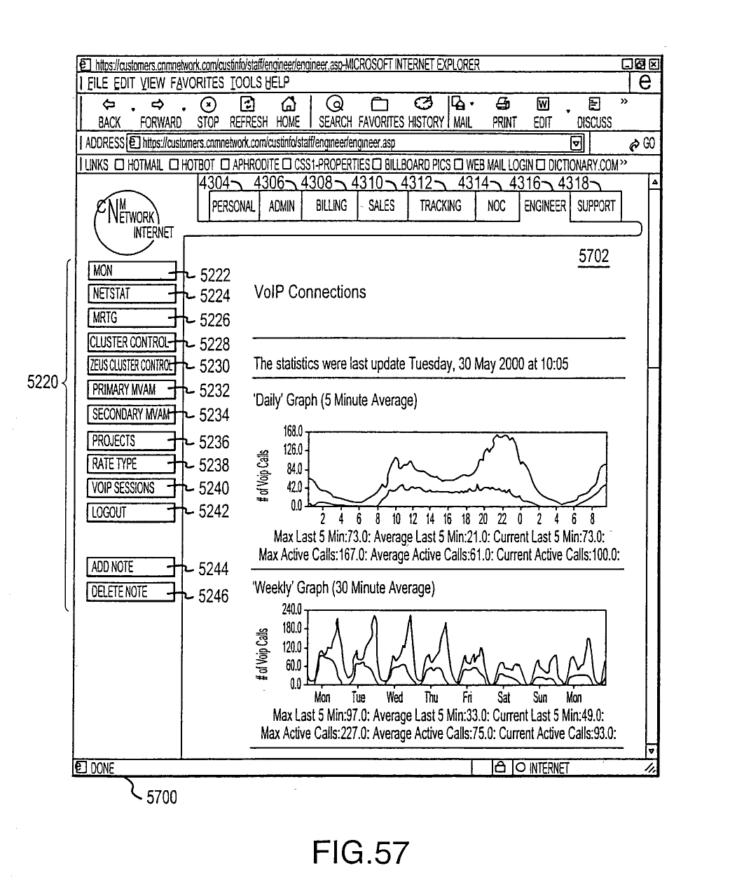

Clicking on the voip (voip): etho hyperlink 5254 causes VoIP Connections Web Page 5700 of FIG. 57 to be displayed on staff Web browser 316. Frame 5702 displays other MRTG graphs showing sampling of the total real time current calls. Every five minutes the number of current calls in the database are counted and the number of calls that have begun and completed in the last five minutes. Those two numbers are fed to the MRTG program which creates the graphs. There is no manual process involved. A group of internally written scripts feed the data to the MRTG program. The MRTG program creates the graphs which are viewed in the Web page. These graphs show the staff member the busy call hour of the network as a whole. It also shows historical data and growth.

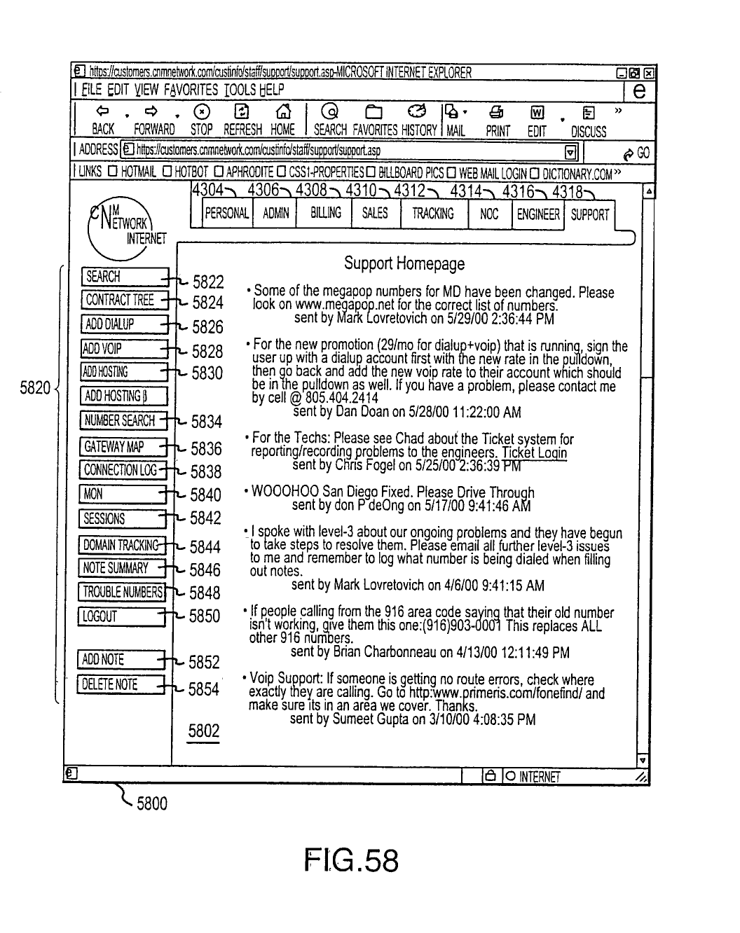

Selecting Support tab 4318 causes Support Homepage Web Page 5800 of FIG. 58 to be displayed on staff Web browser 316. Frame 5802 displays notes posted by staff members pertinent to this Web page. Support tab 4318 gives the staff member access to several select buttons 5820. The staff member may click on any of the select buttons 5820 to access the features represented by the select button.

Selecting Search tab 5822 allows the staff member to search for a customer account by username, account number, phone, etc. (not shown). Selecting Contact Tree tab 5824 allows the staff member to find out who to contact about various problems (not shown). Selecting Add Dialup tab 5826 allows the staff member to add an ISP customer (not shown). Selecting Add VoIP tab 5828 allows the staff member to add a VoIP customer (not shown). Selecting Add Hosting tab 5830 allows the staff member to add a Web hosting customer (not shown). Selecting Number Search tab 5834 allows the staff member to find a local ISP or VoIP gateway number (not shown). Selecting Gateway Map tab 5836 allows the staff member to see what gateways have what PSTN numbers assigned to them (not shown). Selecting Connection Log tab 5838 allows the staff member to search the VoIP log for errors (not shown). Selecting Mon tab 5840 allows the staff member to access a limited monitoring system interface (not shown) that provides system availability information and monitoring. Only staff members with a high security level can access the monitoring system. Staff members with lower security levels are thus prevented from viewing sensitive system information. The monitoring system Selecting Sessions tab 5842 allows the staff member to see currently connected dialup users (not shown). Selecting Domain Tracking tab 5844 allows the staff member to track domain setup completion (not shown). There are several external entities and functions that must interact with the VoIP private network in order for a virtual domain to operate properly. This function lets the staff members track,/maintain which external requirements have been completed. When the virtual domain is registered with the Domain Name Registrar and the domain setup is complete, this function allows the staff member to notify the customer that setup is complete. Selecting Note Summary tab 5846 allows the staff member to search a customer “note” database to find potential recurring issues (not shown). Selecting Trouble Numbers tab 5848 allows the staff member to track the number of customer complaints regarding specific access numbers (not shown). A date selection menu is provided to query the number of complaints for each Access Number. For example, a staff member can select a date range from Jan. 1, 2000 to Jan. 31, 2000 and a list of the number of complaints for each Access Number. This tool is for both Dialup Internet Access Numbers and VoIP Access Numbers. Selecting Add Note tab 5852 allows the staff member to add a note (not shown) is to the Support Homepage Web Page 5800 of FIG. 58. Selecting Delete Note tab 5854 allows the staff member to delete a note (not shown) to the Support Homepage Web Page 5800 of FIG. 58.

Having described a presently preferred embodiment of the present invention, it will be understood by those skilled in the art that many changes in construction and circuitry and widely differing embodiments and applications of the invention will suggest themselves without departing from the scope of the present invention, as defined in the claims. The disclosures and the description herein are intended to be illustrative and are not in any sense limiting of the invention, defined in scope by the following claims.

What is claimed is:

1. A method for transporting voice, data, and video telephony comprising:
receiving a digital data stream within a first edge gateway;
converting said digital data stream into at least one IP datagram;
transmitting said at least one IP datagram from said first edge gateway to a WAN switch;
encapsulating said at least one IP datagram into at least one ATM cell;
transmitting said at least one ATM cell from said WAN switch to a remote WAN switch over a pre-established virtual circuit over a WAN backbone;
decapsulating said at least one IP datagram from said at least one ATM cell;
transmitting said at least one decapsulated IP datagram from said remote-WAN switch to a second edge gateway;
establishing a connecting circuit from said second edge gateway to an external communications network;
decoding and decompressing said at least one decapsulated IP datagram; and
transmitting said at least one decoded and decompressed decapsulated IP datagram from said second edge gateway over said connecting circuit.

2. A system for transporting voice, data, and video telephony comprising:
a first edge gateway for converting a digital data stream into at least one IP datagram;
a first WAN switch for encapsulating said at least one IP datagram into at least one ATM cell;
a second WAN switch for decapsulating said at least one IP datagram from said at least one ATM cell;
a WAN backbone for connecting said first and second WAN switches;
a virtual circuit pre-established between said first and second WAN switches over said WAN backbone for transporting said at least one ATM cell from said first WAN switch to said second WAN switch; and
a second edge gateway for decoding and decompressing said at least one decapsulated IP datagram, for establishing a connecting circuit to an external communications network, and for transmitting said decoded and decompressed decapsulated IP datagram over said connecting circuit.
